(19) United States
(12) Patent Application Publication
(10) Pub. No.: US 2026/0155094 A1
(43) Pub. Date: Jun. 4, 2026

(54) DISPLAY PANEL, DRIVING METHOD THEREOF, AND DISPLAY APPARATUS

(71) Applicant: Wuhan Tianma Microelectronics Co., Ltd., Wuhan (CN)

(72) Inventors: Xiaowen LI, Wuhan (CN); Wenshuai ZHANG, Wuhan (CN)

(73) Assignee: Wuhan Tianma Microelectronics Co., Ltd., Wuhan (CN)

(21) Appl. No.: 19/393,528

(22) Filed: Nov. 18, 2025

(30) Foreign Application Priority Data
Nov. 29, 2024 (CN) 202411752818.9

(51) Int. Cl. G09G 3/32

(52) U.S. Cl. CPC G09G 3/32; G09G 2310/0267; G09G 2310/0286; G09G 2310/08; G09G 2330/021

(57) ABSTRACT

Embodiments of the present application provide a display panel, a driving method thereof, and a display apparatus. A shift register in the display panel comprises a plurality of cascaded shift register units, each of the shift register units comprises a control module, a first output module, and a second output module, wherein the first output module is connected to at least one output terminal of the control module, and the second output module is connected to at least one output terminal of the control module and/or to an output terminal of the first output module; the control module is configured to output a control signal based at least on a first input signal; the first output module is configured to output a first scan signal based at least on the control signal output by the control module, a high level in the first scan signal being an enable level.

### CROSS-REFERENCE TO RELATED APPLICATION

This application claims priority to Chinese Patent Application No. 202411752818.9, filed on Nov. 29, 2024, which is hereby incorporated by reference in its entirety.

### TECHNICAL FIELD

The present application relates to the technical field of display, and in particular to a display panel, a driving method thereof, and a display apparatus.

### BACKGROUND

In existing technology, pixel circuits that incorporate both IGZO (Indium Gallium Zinc Oxide) and LTPS (Low Temperature Poly-Silicon) transistors have become a mainstream design. These pixel circuits require multiple sets of drive signals to operate. Currently, the design uses three sets of driver circuits per side, or a total of six sets of driver circuits on both sides. The multiple sets of driver circuits limit further reduction of the panel bezel and also result in excessive power consumption.

### SUMMARY

Embodiments of the present application provide a display panel, a driving method thereof, and a display apparatus to solve the technical problems of narrowing borders and reducing power consumption.

In a first aspect, the embodiments of the present application provide a display panel comprising a shift register, the shift register comprises a plurality of cascaded shift register units, each of the shift register units comprises a control module, a first output module, and a second output module, wherein the first output module is connected to at least one output terminal of the control module, and the second output module is connected to at least one output terminal of the control module, and/or to an output terminal of the first output module;
the control module is configured to output a control signal based at least on a first input signal;
the first output module is configured to output a first scan signal based at least on the control signal output by the control module, a high level of the first scan signal being an enable level; and
the second output module is configured to output at least one second scan signal based at least on the control signal output by the control module and/or a signal output by the first output module, a low level in the second scan signal being an enable level.

In a second aspect, the embodiments of the present application provide a display apparatus comprising a display panel which comprises a shift register, the shift register comprising a plurality of cascaded shift register units, each of the plurality of shift register units comprising a control module, a first output module, and a second output module, wherein the first output module is connected to at least one output terminal of the control module, and the second output module is connected to at least one output terminal of the control module and/or to an output terminal of the first output module; the control module is configured to output a control signal based at least on a first input signal; the first output module is configured to output a first scan signal based at least on the control signal output by the control module, a high level of the first scan signal being an enable level; and the second output module is configured to output at least one second scan signal based at least on the control signal output by the control module and/or a signal output by the first output module, a low level in the second scan signal being an enable level.

In a third aspect, the embodiments of the present application further provide a method for driving a display panel. The display panel includes a shift register, the shift register comprises a plurality of cascaded shift register units, each of the shift register units comprises a control module, a first output module, and a second output module, the first output module is connected to at least one output terminal of the control module, and the second output module is connected to at least one output terminal of the control module, and/or to the output terminal of the first output module;
the driving method comprises:
providing a first input signal to the control module in each of the shift register units, and controlling the control module to output a control signal based at least on the first input signal;
controlling the first output module to output a first scan signal based at least on the control signal output by the control module, wherein a high level in the first scan signal serves as an enable level; and
controlling the second output module to output at least one second scan signal based at least on the control signal output by the control module and/or a signal output by the first output module, wherein a low level in the second scan signal serves as an enable level.

### BRIEF DESCRIPTION OF THE DRAWINGS

To more clearly illustrate the embodiments of the present application or the technical solutions in the prior art, the following briefly introduces the drawings required for use in the description of the embodiments or the prior art. Apparently, the drawings described below are some embodiments of the present application. Those skilled in the art can derive other drawings based on these drawings without inventive effort.

FIG. 1 is a schematic diagram of a pixel circuit provided by an embodiment of the present application;

FIG. 2 is an operating timing diagram of the pixel circuit in FIG. 1;

FIG. 3 is another operating timing diagram of the pixel circuit in FIG. 1;

FIG. 4 is a schematic diagram of a circuit layout of a display panel in the related art;

FIG. 5 is a schematic diagram of a shift register unit provided by an embodiment of the present application;

FIG. 6 is another schematic diagram of a shift register unit provided by an embodiment of the present application;

FIG. 7 is another schematic diagram of a shift register unit provided by an embodiment of the present application;

FIG. 8 is an operating timing diagram of a shift register unit provided by an embodiment of the present application;

FIG. 9 is another operating timing diagram of a shift register unit provided by an embodiment of the present application;

FIG. 10 is a schematic diagram of a cascade of shift register units provided by an embodiment of the present application;

FIG. 11 is another schematic diagram of a cascade of shift register units provided by an embodiment of the present application;

FIG. 12 is another schematic diagram of a shift register unit provided by an embodiment of the present application;

FIG. 13 is another schematic diagram of a shift register unit provided by an embodiment of the present application;

FIG. 14 is another operating timing diagram of a shift register unit provided by an embodiment of the present application;

FIG. 15 is another operating timing diagram of a shift register unit provided by an embodiment of the present application;

FIG. 16 is another schematic diagram of a cascade of shift register units provided by an embodiment of the present application;

FIG. 17 is another schematic diagram of a cascade of shift register units provided by an embodiment of the present application;

FIG. 18 is another schematic diagram of a shift register unit provided by an embodiment of the present application;

FIG. 19 is another schematic diagram of a shift register unit provided by an embodiment of the present application;

FIG. 20 is another schematic diagram of a shift register unit provided by an embodiment of the present application;

FIG. 21 is another schematic diagram of a shift register unit provided by an embodiment of the present application;

FIG. 22 is another schematic diagram of a shift register unit provided by an embodiment of the present application;

FIG. 23 is another schematic diagram of a shift register unit provided by an embodiment of the present application;

FIG. 24 is another operating timing diagram of a shift register unit provided by an embodiment of the present application;

FIG. 25 is another operating timing diagram of a shift register unit provided by an embodiment of the present application;

FIG. 26 is another schematic diagram of a cascade of shift register units provided by an embodiment of the present application;

FIG. 27 is another operating timing diagram of a shift register unit provided by an embodiment of the present application;

FIG. 28 is another operating timing diagram of a shift register unit provided by an embodiment of the present application;

FIG. 29 is another schematic diagram of a cascade of shift register units provided by an embodiment of the present application;

FIG. 30 is another schematic diagram of a shift register unit provided by an embodiment of the present application;

FIG. 31 is another operating timing diagram of a shift register unit provided by an embodiment of the present application;

FIG. 32 is another schematic diagram of a shift register unit provided by an embodiment of the present application;

FIG. 33 is another schematic diagram of a shift register unit provided by an embodiment of the present application;

FIG. 34 is another operating timing diagram of a shift register unit provided by an embodiment of the present application;

FIG. 35 is another schematic diagram of a cascade of shift register units provided by an embodiment of the present application;

FIG. 36 is another schematic diagram of a shift register unit provided by an embodiment of the present application;

FIG. 37 is another schematic diagram of a shift register unit provided by an embodiment of the present application;

FIG. 38 is another schematic diagram of a shift register unit provided by an embodiment of the present application;

FIG. 39 is another timing diagram of a shift register unit provided by an embodiment of the present application;

FIG. 40 is another schematic diagram of a shift register unit provided by an embodiment of the present application;

FIG. 41 is another schematic diagram of a shift register unit provided by an embodiment of the present application;

FIG. 42 is a schematic diagram of a display panel provided by an embodiment of the present application;

FIG. 43 is a schematic diagram of a circuit layout of a display panel provided by an embodiment of the present application;

FIG. 44 is another schematic diagram of a display panel provided by an embodiment of the present application;

FIG. 45 is another schematic diagram of a circuit layout of a display panel provided by an embodiment of the present application; and

FIG. 46 is a schematic diagram of a display apparatus provided by an embodiment of the present application.

### DETAILED DESCRIPTION

To further clarify the objectives, technical solutions, and advantages of the embodiments of the present application, the technical solutions of the embodiments in the present application will be described clearly and completely below in conjunction with the drawings in the embodiments of the present application, apparently, the described embodiments are only some embodiments of the present application, rather than all embodiments. Based on the embodiments in the present application, all other embodiments obtained by those skilled in the art without making creative efforts are within the scope of protection of the present application.

The terms used in the embodiments of the present application are intended solely to describe specific embodiments and are not intended to limit the present application. The singular forms “a,” “the,” and “this” used in the embodiments of the present application and the appended claims are intended to include the plural forms, unless the context clearly indicates otherwise.

It will be apparent to those skilled in the art that various modifications and variations can be performed to the present application without departing from the gist or scope of the present application. Therefore, the present application is intended to cover modifications and variations of the present application that fall within the scope of the corresponding claims (claimed technical solutions) and their equivalents. It should be noted that the embodiments provided in the embodiments of the present application may be combined with each other unless there is any inconsistency.

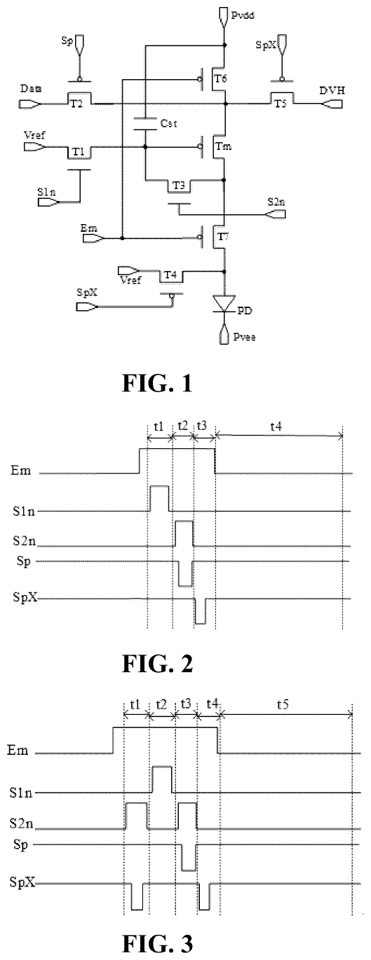

FIG. 1 is a schematic diagram of a pixel circuit provided by an embodiment of the present application. FIG. 2 is an operating timing diagram of an of the pixel circuit in FIG. 1. FIG. 3 is another operating timing diagram of the pixel circuit in FIG. 1. As shown in FIG. 1, the pixel circuit includes a drive transistor Tm, a gate reset transistor T1, a data write transistor T2, a threshold compensation transistor T3, an electrode reset transistor T4, a bias transistor T5, a first light-emitting control transistor T6, a second light-emitting control transistor T7, and a storage capacitor Cst. The drive transistor Tm is connected in series between the first light-emitting control transistor T6 and second light-emitting control transistor T7. The first light-emitting control transistor T6 receives a first power supply voltage Pvdd. The second light-emitting control transistor T7 and the electrode reset transistor T4 are each connected to one electrode of the light-emitting device PD, the other electrode of the light-emitting device PD receives a second power supply voltage Pvee. The active layers of the threshold compensation transistor T3 and the gate reset transistor T1 comprise metal oxide, and both are n-type transistors. The active layers of the other transistors in the pixel circuit comprise silicon, and are p-type transistors. This configuration reduces leakage current from the threshold compensation transistor T3 and the gate reset transistor T1 to the gate of the drive transistor Tm, thereby improving the gate potential stability of the drive transistor Tm. In addition, the bias transistor T5 is configured to write a bias signal DVH into one electrode of the drive transistor Tm to adjust the bias state of the drive transistor Tm and improve the hysteresis effect of the drive transistor Tm. The bias signal DVH may be a constant voltage signal.

In an embodiment, referring to FIG. 2, the operation of the pixel circuit includes a gate reset phase, a data writing phase, a biasing phase, and a light-emitting phase. During period t1, a scan signal S1n provides an enable signal to control the gate reset transistor T1 to be turned on, writing the reset signal Vref to the gate of the drive transistor Tm to reset the gate of the drive transistor Tm. During period t2, a scan signal S2n provides an enable signal, and scan signal Sp provides an enable signal to turn on the threshold compensation transistor T3 and the data write transistor T2, so as to write the data voltage Data to the gate of the drive transistor Tm. During period t3, a scan signal SpX provides an enable signal to control the bias transistor T5 to be turned on, a writing the bias signal DVH into the first electrode of the drive transistor Tm to adjust the bias state of the drive transistor Tm. During period t4, the light-emitting control signal Em provides an enable signal, turning on the first light-emitting control transistor T6 and the second light-emitting control transistor T7. The drive transistor Tm generates a drive current under control of its gate and supplies the drive current to the light-emitting device PD to control the light-emitting device PD for emitting light.

In another embodiment, referring to FIG. 3, during the operation of the pixel circuit, the period t1 represents the first biasing phase, the period t2 represents the gate reset phase, the period t3 represents the data writing phase, period t4 represents the second biasing phase, and period t5 represents the light-emitting phase. During period t1, the scan signal S2n provides an enable signal, and the scan signal SpX provides an enable signal. The threshold compensation transistor T3 and the bias transistor T5 are turned on to write the bias signal DVH to the gate of the drive transistor Tm, optimizing the hysteresis effect of the drive transistor Tm. The electrode reset transistor T4 is turned on to write the reset signal Vref to the electrode of the light-emitting device PD. During period t2, the scan signal S1n provides an enable signal, and the gate reset transistor T1 is turned on to write the reset signal Vref to the gate of the drive transistor Tm, resetting the gate of the drive transistor Tm. During period t3, a scan signal S2n and a scan signal Sp provide enable signals, turning on the threshold compensation transistor T3 and the data write transistor T2, writing data voltage Data to the gate of drive transistor Tm. During period t4, a scan signal SpX again provides an enable signal, controlling bias transistor T5 to be turned on and write bias signal DVH to the first electrode of drive transistor Tm, so as to adjust the bias state of drive transistor Tm. During period t5, a light-emitting control signal Em provides an enable signal, turning on first light-emitting control transistor T6 and second light-emitting control transistor T7. The drive transistor Tm generates a drive current under the control of its gate and supplies the drive current to light-emitting device PD, thereby controlling the light-emitting device PD to emit light.

The pixel circuit includes an n-type transistor and a p-type transistor. For example, the gate reset transistor T1 and the threshold compensation transistor T3 have a high enable level, while other transistors, such as the data write transistor T2, have a low enable level. The scan signal with a low level as the enable level and the scan signal with a high level as the enable level need to be provided by different driver circuits. To drive the pixel circuits provided in the embodiment of FIG. 1, multiple sets of driver circuits are required within the display panel.

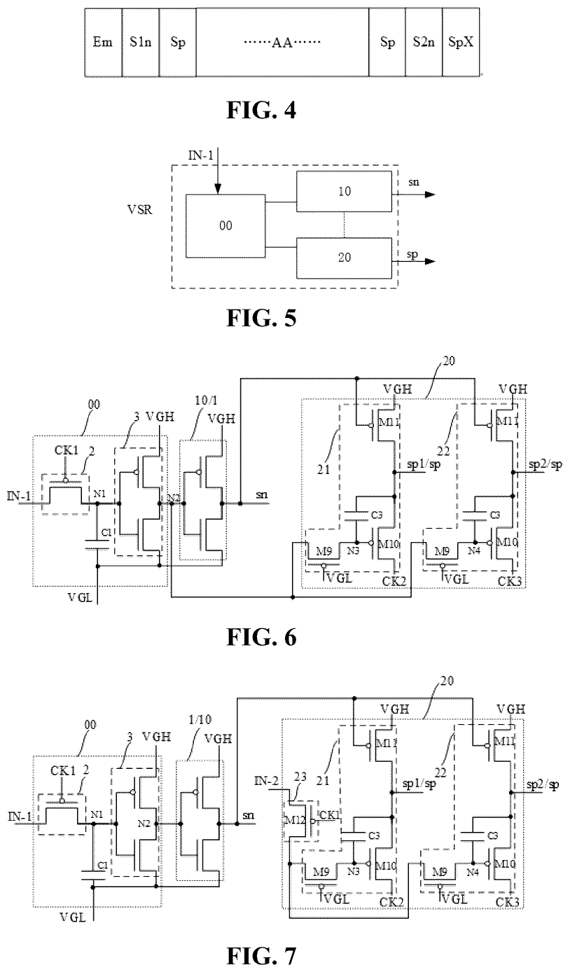

FIG. 4 is a schematic diagram of the circuit layout of a display panel in the related art. As shown in FIG. 4, a light-emitting driver circuit Em, a first scan driver circuit S1n, a second scan driver circuit S2n, a third scan driver circuit Sp, and a fourth scan driver circuit SpX are provided on the left and right sides of the display region AA of the display panel. The light-emitting driver circuit Em and the light-emitting control signal Em are labeled the same, and the scan circuits and the scan signals provided thereof are labeled the same, such as the first scan driver circuit S1n providing the scan signal S1n. The light-emitting driver circuit Em, the first scan driver circuit S1n, and the third scan driver circuit Sp are provided on the left side of the display region AA, while the second scan driver circuit S2n, the third scan driver circuit Sp, and the fourth scan driver circuit SpX are provided on the right side. In other words, three driver circuits are provided on each side, which limits further reduction of the panel border. Furthermore, multiple clock signals need to be provided for each of the driver circuits, increasing the power consumption of the display panel.

To address the problems in the related art, an embodiment of the present application provides a display panel comprising a shift register unit capable of outputting a scan signal with a high enable level and a scan signal with a low enable level. A set of shift register units capable of outputting two driving signals can reduce the number of driver circuits in the display panel, save wiring space, and facilitate a narrower border of the display panel. Furthermore, the number of clock signals required can be reduced, thereby lowering the power consumption of the display panel.

FIG. 5 is a schematic diagram of a shift register unit provided by an embodiment of the present application. As shown in FIG. 5, the shift register unit VSR includes a control module 00, a first output module 10, and a second output module 20. The first output module 10 is connected to at least one output terminal of the control module 00, and the second output module 20 is connected to at least one output terminal of the control module 10 and/or to an output terminal of the first output module 10.

The control module 00 is configured to output a control signal based at least on a first input signal IN-1. The pulse level of the first input signal IN-1 is either high level or low level. The type of the first input signal IN-1 is determined based on the specific connection manner and adaptive structure between the modules.

The first output module 10 is configured to output a first scan signal sn based at least on the control signal output by the control module 00. The high level in the first scan signal sn is an enable level. The first scan signal sn is capable of driving an n-type transistor. The first scan signal sn is capable of driving the gate reset transistor T1 and/or the threshold compensation transistor T3 in the pixel circuit of FIG. 1.

The second output module 20 is configured to output at least one second scan signal sp based at least on the control signal output by the control module 00 and/or the signal output by the first output module 10. The low level in the second scan signal sp is an enable level. The second scan signal sp is capable of driving a p-type transistor, such as the data write transistor T2 in the pixel circuit of FIG. 1. In embodiments of the present application, the second output module 20 is capable of outputting one, two, or multiple second scan signals. When the two second scan signals sp output by the second output module 20 have a phase difference, when the display panel is driven row by row, the two second scan signals sp output by the second output module 20 can each drive the data write transistors T2 in a pixel row.

An embodiment of the present application provides a display panel in which a shift register unit VSR includes a control module 00, a first output module 10, and a second output module 20. After receiving a first input signal IN-1, the control module 00 can enable the first output module 10 and the second output module 20 each to output a driving signal. The first scan signal sn output by the first output module 10 can be configured to drive an n-type transistor, and the second scan signal sp output by the second output module 20 can be configured to drive a p-type transistor. A shift register composed of multiple cascaded shift register units VSR can serve as a driver circuit to drive two types of transistors in a pixel circuit, which can reduce the number of driver circuits in the display panel, save display panel wiring space, facilitate narrowing the bezel of the display panel, and also reduce the number of clock signals, thereby reducing the power consumption of the display panel.

The embodiments of the present application also provide a method for driving a display panel, which can be configured to drive the display panel provided by the embodiments of the present application. Referring to FIG. 5, the driving method includes:

providing a first input signal IN-1 to a control module 00 in a shift register unit VSR, and controlling the control module 00 to output a control signal based at least on the first input signal IN-1;

controlling the first output module 10 to output a first scan signal sn based at least on the control signal output by the control module 00, with a high level in the first scan signal sn being an enable level; and

controlling the second output module 20 to output at least one second scan signal sp based at least on the control signal output by the control module 00 and/or a signal output by the first output module 10, with a low level in the second scan signal sp being an enable level.

Using the driving method provided by the embodiments of the present application, the control module 00 in the shift register unit VSR can control the first output module 10 and the second output module 20 to each output a driving signal after receiving the first input signal IN-1. The two driving signals output by the shift register unit VSR can drive two types of transistors in the pixel circuit, which reduces the number of driver circuits in the display panel, saving the wiring space of the display panel and facilitating a narrower border of the display panel, also reduces the number of clock signals, thereby lowering power consumption of the display panel.

In some embodiments of the present application, by configuring the structure of the first output module 10 and the signals received thereof, the first output module 10 can output a constant voltage signal based on the control signal output by the control module 00, while the second output module 20 normally outputs the second scan signal sp, which enables the shift register unit VSR to have two operating modes. In the first mode, the shift register unit VSR outputs the first scan signal sn and at least one second scan signal sp; in the second mode, the shift register unit VSR outputs the constant voltage signal and at least one second scan signal sp. When the first scan signal sn is configured to drive the gate reset transistor and/or the threshold compensation transistor, the display panel can implement a partitioned refresh function. In other embodiments, the first output module 10 only has the function of outputting the first scan signal sn, and the shift register unit VSR has only one operating mode, ie, an operating mode of outputting two driving signals.

The following first describes an embodiment in which a shift register unit has only one operating mode.

In some embodiments, FIG. 6 is another schematic diagram of a shift register unit provided by an embodiment of the present application. As shown in FIG. 6, the control module 00 is configured to output a control signal based on a first input signal IN-1, a first clock signal CK1, a first voltage signal VGL, and a second voltage signal VGH. Optionally, the voltage value of the second voltage signal VGH is greater than the voltage value of the first voltage signal VGL. The first output module 10 is configured to output a first scan signal sn based on the control signal output by the control module 00, the first voltage signal VGL, and the second voltage signal VGH. Optionally, to ensure the signal output performance of the first output module 10, the first voltage signal VGL and the second voltage signal VGH received by the first output module 10 can be provided by separate signal lines. The second output module 20 is configured to output at least one second scan signal sp based on the first voltage signal VGL and the second voltage signal VGH, at least one clock signal, the control signal output by the control module 00, and the signal output by the first output module 10. FIG. 6 illustrates that the clock signals received by the second output module 20 include the second clock signal CK2 and the third clock signal CK3, and that the second output module 20 outputs two second scan signals sp, namely, a first sub-scan signal sp1 and a second sub-scan signal sp2.

In other embodiments, FIG. 7 is another schematic diagram of a shift register unit provided by an embodiment of the present application. As shown in FIG. 7, the control module 00 is configured to output a control signal based on the first input signal IN-1, the first clock signal CK1, the first voltage signal VGL, and the second voltage signal VGH. The first output module 10 is configured to output a first scan signal sn based on the control signal output by the control module 00, the first voltage signal VGL, and the second voltage signal VGH. The second output module 20 is configured to output two second scan signals sp based on the first voltage signal VGL, the second voltage signal VGH, the second clock signal CK2, the third clock signal CK3, the signal output by the first output module 10, and the second input signal IN-2. The two second scan signals sp are the first sub-scan signal sp1 and the second sub-scan signal sp2.

The structure and connection of the first output module 10 and the control module 00 are described. As shown in FIGS. 6 and 7, the first output module 10 includes a first inverter 1. The input terminal of the first inverter 1 is connected to the output terminal of the control module 00. The first inverter 1 outputs a first scan signal sn based on the control signal output by the control module 00. The output terminal of the first inverter 1 serves as the output terminal of the first output module 10. The first inverter 1 is a CMOS inverter, comprising an n-type transistor and a p-type transistor. The ground terminal of the first inverter 1 receives a first voltage signal VGL, and the power supply terminal receives a second voltage signal VGH. Specifically, one terminal of the p-type transistor in the first inverter 1 receives the second voltage signal VGH, and one terminal of the n-type transistor receives the first voltage signal VGL. The control module 00 includes a first submodule 2 and a second inverter 3. The first submodule 2 receives a first input signal IN-1. The input terminals of the first submodule 2 and the second inverter 3 are connected to a first node N1. The output terminal of the second inverter 3 and the input terminal of the first inverter 1 are connected to a second node N2. The first submodule 2 is configured to write the first input signal IN-1 to the input terminal of the second inverter 3 under the control of the first clock signal CK1. The second inverter 3 inverts the phase of the first input signal IN-1 and outputs it. The second inverter 3 is a CMOS inverter comprising an n-type transistor and a p-type transistor. The ground terminal of the second inverter receives the first voltage signal VGL, and the power supply terminal receives the second voltage signal VGH. The first output module 00 further includes a first capacitor C1, which is configured to stabilize the potential of the first node N1. One plate of the first capacitor C1 is connected to the first node N1, and the other plate receives the first voltage signal VGL.

There are various ways to connect the second output module 20 to the control module 00 and/or the first output module 10. In the embodiment of FIG. 6, at least one control terminal of the second output module 20 is connected to the output terminal of the first inverter 1, and at least one input terminal of the second output module 20 is connected to the input terminal of the first inverter 1, that is, to the output terminal of the control module 00. In the embodiment of FIG. 7, at least one control terminal of the second output module 20 is connected to the output terminal of the first inverter 1, and at least one input terminal of the second output module 20 receives the second input signal IN-2.

Optionally, the second output module 20 includes a submodule configured to output a second scan signal sp based at least on a first voltage signal VGL, a second voltage signal VGH, and a clock signal. The embodiments of FIG. 6 and FIG. 7 take for example that the second output module 20 includes two submodules including the submodule 21 and the submodule 22. The submodule 21 is configured to output a first sub-scan signal sp1 based at least on a first voltage signal VGL, a second voltage signal VGH, and a second clock signal CK2, and the submodule 22 is configured to output a second sub-scan signal sp2 based at least on a first voltage signal VGL, a second voltage signal VGH, and a third clock signal CK3. Specifically, as shown in FIG. 6, each submodule includes a ninth transistor M9, a tenth transistor M10, and an eleventh transistor M11, and a third capacitor C3.

An embodiment of the present application also provides another display panel driving method that can be used to drive a display panel including the shift register unit of the embodiment of FIG. 6. The driving method includes:

providing a first input signal IN-1, a first clock signal CK1, a first voltage signal VGL, and a second voltage signal VGH to a control module 00, and controlling the control module 00 to output a control signal;

controlling the first output module 10 to begin outputting a high-level signal of a first scan signal sn during a period when a pulse of the first input signal IN-1 overlaps a first low level of the first clock signal CK1, based at least on the control signal output by the control module 00; and controlling the first output module 10 to stop outputting a high-level signal of the first scan signal sn during a period when a non-pulse of the first input signal IN-1 overlaps a second low level of the first clock signal CK1, based at least on the control signal output by the control module 00. The second low level is the sth pulse signal after the first low level, where s is a positive integer. s can be 1, 2, 3, etc., and the size of s affects the pulse width of the first scan signal sn. In some embodiments, the pulse of the first input signal IN-1 is a high-level pulse, and the non-pulse of the first input signal IN-1 is a low-level signal. In other embodiments, the pulse of the first input signal IN-1 is a low-level pulse, and the non-pulse of the first input signal IN-1 is a high-level signal.

During periods when the first clock signal CK1 provides a first low level and a second low level, the second output module 20 is controlled to output at least one low-level signal of the second scan signal sp based at least on the control signal output by the control module 00 and/or the signal output by the first output module 10.

In the driving method provided in the embodiments of the present application, the overlap between the pulse/non-pulse of the first input signal IN-1 and the high/low level of the first clock signal CK1 affects the control signal output by the control module 00, thereby affecting the signal outputs of the first output module 10 and the second output module 20. During the period when a pulse of the first input signal IN-1 overlaps a low level of the first clock signal CK1, the first output module 10, based on the control signal output by the control module 00, begins outputting a high-level signal of the first scan signal sn. Then, when another low level of the first clock signal CK1 overlaps a non-pulse of the first input signal IN-1, the first output module 10 stops outputting a high-level signal of the first scan signal sn. The high-level pulse width of the first scan signal sn output by the first output module 10 is related to the period of the first clock signal CK1. For example, when s=1, the high-level pulse width of the first scan signal sn is the same as the period of the first clock signal CK1. Furthermore, during the first low level and second low level of the first clock signal CK1, the second output module 20 is controlled to output at least one low-level signal of the second scan signal sp, which allows the high-level period of the first scan signal sn to overlap the low-level period of the second scan signal sp, so that it easier to cooperate the first scan signal sn and the second scan signal sp with the signal timing required by the pixel circuit in the application.

The following timing diagrams provide a better understanding of the driving method provided by the embodiments of the present application.

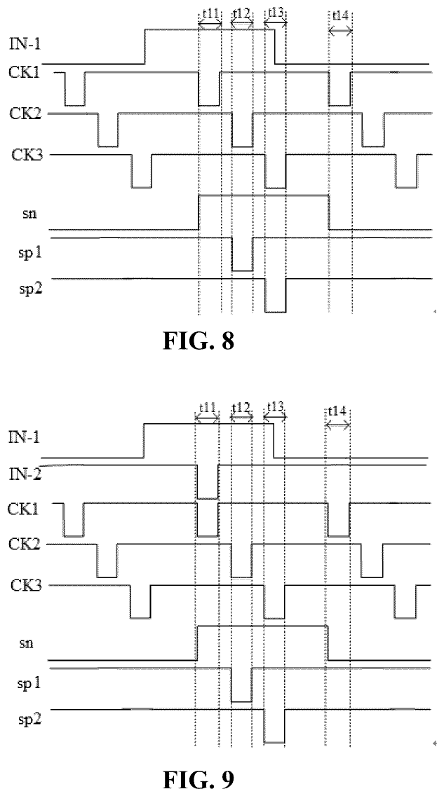

FIG. 8 is an operating timing diagram of a shift register unit provided by an embodiment of the present application. The timing diagram provided in FIG. 8 is applicable to the shift register unit provided in the embodiment of FIG. 6. In conjunction with FIG. 8 and FIG. 6, the pulse level of the first input signal IN-1 is a high level, and the pulse level of the first input signal IN-1 at least partially overlaps the low-level period of the first clock signal CK1.

During period t11, when the first clock signal CK1 provides a low-level period, the first submodule 2 is turned on and writes the high level of the first input signal IN-1 to the first node N1, so that the potential of the first node N1 is high. The second inverter 3 inputs a high level and outputs a low level, so that the potential of the second node N2 is low. The input terminal of the first inverter 1 is connected to the second node N2. When the potential of the second node N2 is low, the output terminal of the first inverter 1 outputs a high-level signal. That is, the first output module 10 outputs a high-level signal of the first scan signal sn from the period t11. During periods t12 and t13, the first clock signal CK1 is at a high level, the first submodule 2 is controlled to be turned off. The first node N1 remains at a high level, and the second node N2 remains at a low level. The first output module 10 continues to output a high-level signal of the first scan signal sn. During period t14, the first clock signal CK1 is again a low-level signal to control the first submodule 2 to be turned on and write the low level of the first input signal IN-1 into the first node N1. Then, the potential of the first node N1 is low and the potential of the second node N2 is high. The output terminal of the first inverter 1 outputs a low-level signal. That is, the first output module 10 outputs a low-level signal of the first scan signal sn from the period t14.

In addition, at least one control terminal of the second output module 20 is connected to the output terminal of the first output module 10, and at least one input terminal of the second output module 20 is connected to the output terminal of the control module 00. During period t11, the second node N2 is at a low level. The second node N2 writes a low-level signal to the third node N3 via the ninth transistor M9 in the submodule 21, and writes a low-level signal to the fourth node N4 via the ninth transistor M9 in the submodule 22. During the period t12 when the second clock signal CK2 is at a low level, the second node N2 remains at a low potential, and the third node N3 remains at a low potential, controlling the tenth transistor M10 to be turned on and output the low-level signal of the second clock signal CK2. Simultaneously, the output terminal of the first output module 10 outputs a high-level signal, controlling the eleventh transistor M11 to be turned off. At this time, the second output module 20 outputs a low-level signal of the first sub-scan signal sp1. The submodule 22 and the submodule 21 have the same operating mode. During the period t13 when the third clock signal CK3 is at a low level, the fourth node N4 is at a low potential, controlling the tenth transistor M10 to be turned on and output the low-level signal of the third clock signal CK3. Simultaneously, the output terminal of the first output module 10 outputs a high-level signal, controlling the eleventh transistor M11 to be turned off. At this time, the second output module 20 outputs a low-level signal of the second sub-scan signal sp2.

During the period from t11 to t14, the shift register unit outputs the first scan signal sn, the first sub-scan signal sp1, and the second sub-scan signal sp2. The low-level start time of the second sub-scan signal sp2 is later than the low-level start time of the first sub-scan signal sp1. That is, when the shift register unit outputs two or more second scan signals, there is a phase difference between the different second scan signals.

In some embodiments of the present application, FIG. 8 illustrates that the first clock signal CK1 provides two adjacent pulse signals including a first low level and a second low level, i.e., s=1. Referring to the timing diagram shown in FIG. 8, during the periods when the first clock signal CK1 provides the first low level (the first low level that overlaps the high-level pulse of the first input signal IN-1) and the second low level, controlling the second output module 20 to output at least one low-level signal of the second scan signal sp includes: controlling the second output module 20 to output at least one low-level signal of the second scan signal sp based on at least one clock signal, wherein the low-level period of the clock signal received by the second output module 20 corresponds to the low-level period of the second scan signal sp. The embodiment of FIG. 8 takes for example that the second output module 20 outputs two second scan signals sp. The low level of the second clock signal CK2 controls the output of the low-level signal of the first sub-scan signal sp1, and the low level of the third clock signal CK3 controls the output of the low-level signal of the second sub-scan signal sp2. That is, when the second output module 20 outputs two second scan signals sp, at least two clock signals are required to be input.

As shown in FIG. 7, the shift register unit further includes a second input module 23. One input terminal of the submodule 21 and one input terminal of submodule 22 each receive the second input signal IN-2 through the second input module 23. The second input module 23 is configured to write the second input signal IN-2 to one input terminal of the submodule 21 and to one input terminal of submodule 22 each, based on the control of the first clock signal CK1. Specifically, the second input module 23 includes a twelfth transistor M12, the control terminal of which receives the first clock signal CK1, the first terminal of which receives the second input signal IN-2, and the second terminal of which is connected to an input terminal of the submodule 21 and an input terminal of the submodule 22.

An embodiment of the present application also provides a method for driving the shift register unit shown in the embodiment of FIG. 7. The method includes controlling the second output module 20 to output at least one low-level signal of the second scan signal sp based at least on a second input signal IN-2, a control signal output by the control module 00, or a signal output by the first output module 10. The second input signal IN-2 is written to the second output module 20 during a period when the first clock signal CK1 is at a low level. The period when the pulse level of the second input signal IN-2 is written into the second output module 20 may be a period when the first clock signal CK1 provides the first low level, or a low-level period after the first low level. The following timing diagram takes an example that the pulse level of the second input signal IN-2 is written into the second output module 20 during the period when the first clock signal CK1 provides the first low level as an example. The driving method can be understood in conjunction with the following timing diagram.

FIG. 9 is another operating timing diagram of a shift register unit provided by an embodiment of the present application. The timing diagram shown in FIG. 9 can be applied to the shift register unit shown in FIG. 7. In conjunction with FIGS. 9 and 7, the pulse level of the first input signal IN-1 is a high level, and the pulse level of the second input signal IN-2 is a low level. During period t11, the first clock signal CK1 provides a low level, the first submodule 2 is turned on, and the high level of the first input signal IN-1 is written to the first node N1. The first node N1 is at a high potential, the second node N2 is at a low potential, and the first output module 10 outputs a high-level signal of the first scan signal sn. During periods t12 and t13, the first node N1 maintains at a high potential, the second node N2 maintains at a low potential, and the first output module 10 continuously outputs a high-level signal of the first scan signal sn. During period t14, the first clock signal CK1 provides a low level, the first submodule 2 is turned on, and the low level of the first input signal IN-1 is written to the first node N1. The first node N1 is at a low potential, the second node N2 is at a high potential, and the first output module 10 outputs a low-level signal of the first scan signal sn. The low-level pulse of the second input signal IN-2 at least partially overlaps the low level of the first clock signal CK1. During period t11, the first clock signal CK1 controls the second input module 23 to be turned on and write the low level of the second input signal IN-2 to the third node N3 of submodule 21 and the fourth node N4 of submodule 23 each, so that the first sub-scan signal sp1 output by the second output module 20 is a low level during the period t12 when the second clock signal CK2 is a low level, and the second sub-scan signal sp2 output by the second output module 20 is a low level during the period t13 when the third clock signal CK3 is a low level.

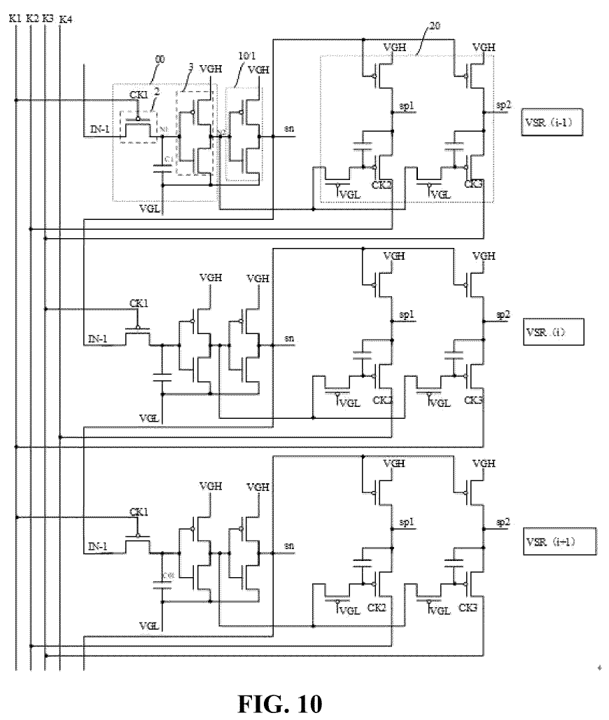

In some embodiments, FIG. 10 is a schematic diagram of a cascade of shift register units provided by an embodiment of the present application. FIG. 10 illustrates a cascade arrangement of the shift register units shown in FIG. 6. In the embodiment of FIG. 6, at least one control terminal of the second output module 20 is connected to the output terminal of the first inverter 1, and at least one input terminal of the second output module 20 is connected to the input terminal of the first inverter 1. The pulse level of the first input signal IN-1 is a high level. FIG. 10 illustrates three cascaded shift register units VSR, namely, the shift register unit VSR(i−1) at the (i−1)^{th} stage, the shift register unit VSR(i) at the i^{th} stage, and the shift register unit VSR(i+1) at the (i+1)^{th} stage. As can be seen from FIG. 10, the input terminal of the first submodule 2 in the shift register unit VSR(i) at the i^{th} stage is connected to the output terminal of the first inverter 1 in the shift register unit VSR(i−1) at the (i−1)^{th} stage, where i is an integer, and i≥2. When driving multiple cascaded shift register units in this embodiment, four clock signal lines are required in the display panel, which are a first clock signal line K1, a second clock signal line K2, a third clock signal line K3, and a fourth clock signal line K4 respectively. The clock signals provided by these four clock signal lines have the same period. For example, i is an even number, and then i−1 is an odd number. For the shift register units at the odd-number stages, the first clock signal line K1 provides the first clock signal CK1, the second clock signal line K2 provides the second clock signal CK2, and the third clock signal line K3 provides the third clock signal CK1. For the shift register units at the even-number stages, the third clock signal line K3 provides the first clock signal CK1, the fourth clock signal line K4 provides the second clock signal CK2, and the first clock signal line K1 provides the third clock signal CK1.

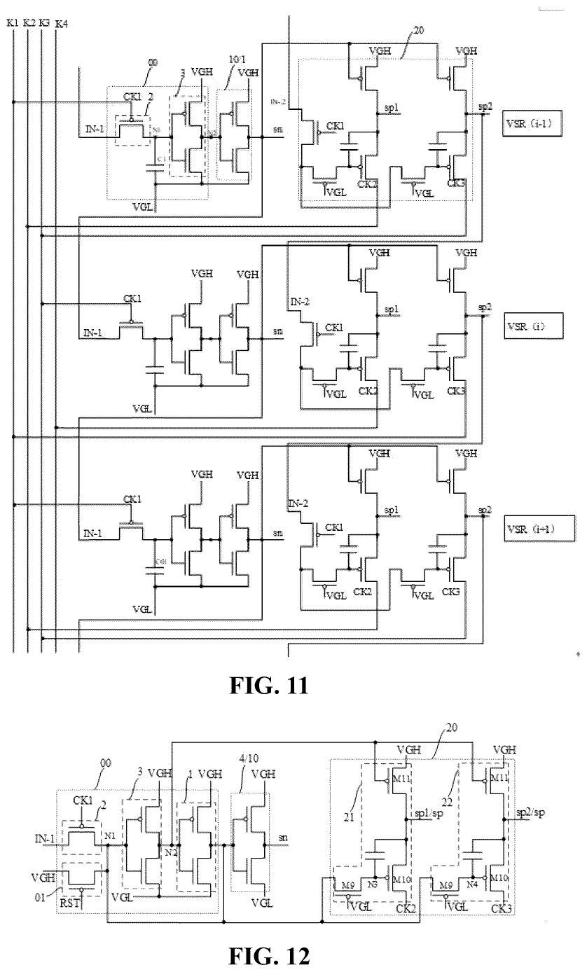

In other embodiments, FIG. 11 is another schematic diagram of a cascade of shift register units provided by an embodiment of the present application. FIG. 11 illustrates a cascade arrangement of the shift register units shown in FIG. 7. In the embodiment of FIG. 7, at least one control terminal of the second output module 20 is connected to the output terminal of the first inverter 1, and at least one input terminal of the second output module 20 receives the second input signal IN-2. The pulse level of the first input signal IN-1 is a high level, and the pulse level of the second input signal IN-2 is a low level. In conjunction with the timing diagram shown in FIG. 9, the low-level start time of the second sub-scan signal sp2 is later than the low-level start time of the first sub-scan signal sp1. FIG. 11 illustrates three cascaded shift register units VSR, namely, the shift register unit VSR(i−1) at the (i−1)^{th} stage, the shift register unit VSR(i) at the i^{th} stage, and the shift register unit VSR(i+1) at the (i+1)^{th} stage. FIG. 11 shows that the input terminal of the first submodule 2 in the shift register unit (i) at the i^{th} stage is connected to the output terminal of the first inverter 1 in the shift register unit VSR(i-1) at the (i−1)^{th} stage, and the input terminal of the second output module 20 in the shift register unit VSR(i) at the i^{th} stage receives the second sub-scan signal sp2 output by the shift register unit VSR(i−1) at the (i−1)^{th} stage, where i is an integer, and i≥2. That is, when the shift register unit outputs two or more second scan signals sp, there is a phase difference between the different second scan signals sp, and the second scan signal with the latest low-level start time is used as the second input signal IN-2 received by the next-stage shift register unit. When driving multiple cascaded shift register units in this embodiment, four clock signal lines need to be provided in the display panel, namely, the first clock signal line K1, the second clock signal line K2, the third clock signal line K3 and the fourth clock signal line K4. The clock signals provided by the four clock signal lines have the same period. For example, i is an even number, and then i−1 is an odd number. For the shift register units at the odd-number stages, the first clock signal line K1 provides the first clock signal CK1, the second clock signal line K2 provides the second clock signal CK2, and the third clock signal line K3 provides the third clock signal CK1. For the shift register units at the even-number stages, the third clock signal line K3 provides the first clock signal CK1, the fourth clock signal line K4 provides the second clock signal CK2, and the first clock signal line K1 provides the third clock signal CK1.

In other embodiments, FIG. 12 is another schematic diagram of a shift register unit provided by an embodiment of the present application. As shown in FIG. 12, the control module 00 is configured to output a control signal based on the first input signal IN-1, the first clock signal CK1, the first voltage signal VGL, and the second voltage signal VGH. The first output module 10 is configured to output a first scan signal sn based on the control signal output by the control module 00, the first voltage signal VGL, and the second voltage signal VGH. The second output module 20 is configured to output two second scan signals sp based on the first voltage signal VGL, the second voltage signal VGH, the second clock signal CK2, the third clock signal CK3, and the signal output by the control module 00. The two second scan signals sp are a first sub-scan signal sp1 and a second sub-scan signal sp2, respectively.

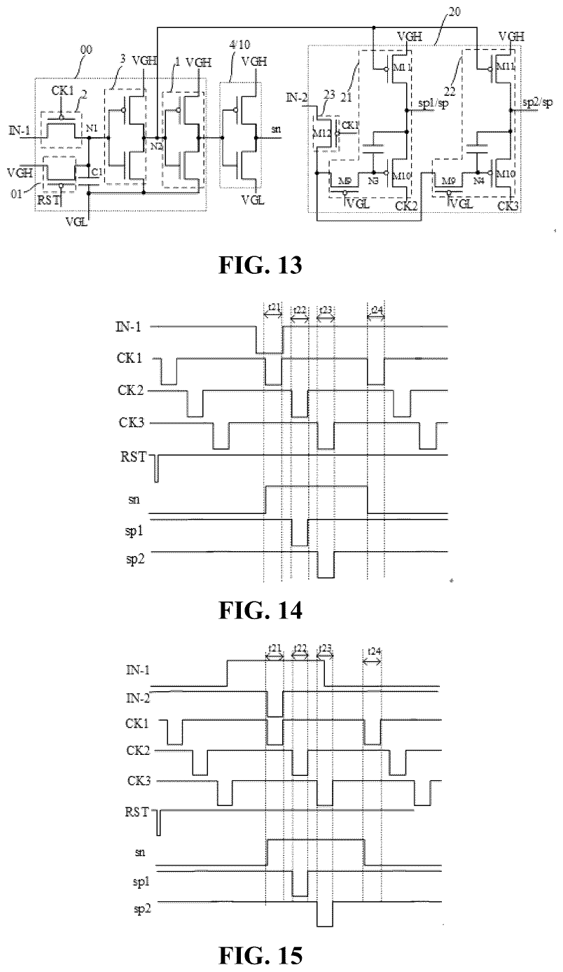

In other embodiments, FIG. 13 is another schematic diagram of a shift register unit provided by an embodiment of the present application. As shown in FIG. 13, the control module 00 is configured to output a control signal based on a first input signal IN-1, a first clock signal CK1, a first voltage signal VGL, and a second voltage signal VGH. The first output module 10 is configured to output a first scan signal sn based on the control signal output by the control module 00, the first voltage signal VGL, and the second voltage signal VGH. The second output module 20 is configured to output a first sub-scan signal sp1 and a second sub-scan signal sp2 based at least on the first voltage signal VGL, the second voltage signal VGH, the second clock signal CK2, and the third clock signal CK3, as well as the signal output by the control module 00 and the second input signal IN-2. As shown in FIGS. 12 and 13, the control module 00 includes a first submodule 2, a first inverter 1, and a second inverter 3. The first submodule 2 receives a first input signal IN-1. The input terminals of the first submodule 2 and the second inverter 3 are connected to a first node N1, and the output terminal of the second inverter 3 and the input terminal of the first inverter 1 are connected to a second node N2. The first submodule 2 is configured to write the first input signal IN-1 to the input terminal of the second inverter 3 under the control of a first clock signal CK1. The input terminal of the first inverter 1 is connected to the output terminal of the second inverter 3. The first output module 10 includes a third inverter 4. The input terminal of the third inverter 4 is connected to the output terminal of the control module 00. The third inverter 4 outputs a first scan signal sn based at least on a control signal output by the control module 00. The third inverter 4 is a CMOS inverter comprising an n-type transistor and a p-type transistor. One terminal of the n-type transistor receives the first voltage signal VGL, and one terminal of the p-type transistor receives the second voltage signal VGH.

In the embodiment of FIG. 12, the input terminal of the second inverter 3 is connected to the first node N1, and the input terminal of the second inverter 3 is connected to the output terminal of the first inverter 1, forming a latch structure. At least one control terminal of the second output module 20 is connected to the output terminal of the second inverter 3, and at least one input terminal of the second output module 20 is connected to the output terminal of the first inverter 1. Furthermore, the embodiment of FIG. 12 illustrates that the control module 00 further includes a reset submodule 01. The reset submodule 01 is configured to write a second voltage signal VGH to the first node N1 to reset the first node N1 under the control of a reset control signal RST. Specifically, the reset submodule 01 includes a p-type transistor, the control terminal of the transistor receives a reset control signal RST, the first terminal of the transistor receives a second voltage signal VGH, and the second terminal of the transistor is connected to the first node N1.

In the embodiment of FIG. 13, a first capacitor C1 is provided, one plate of the first capacitor C1 is connected to the first node N1 and the other plate receives the first voltage signal VGL. The signal at the output terminal of the first inverter 1 is required when cascading the shift register units. The configuration of the embodiment of FIG. 13 allows the first node N1 not to be associated with the signal at the output terminal of the first inverter 1, preventing the potential of the first node N1 from being interfered by the next-stage shift register unit. In the embodiment of FIG. 13, at least one control terminal of the second output module 20 is connected to the output terminal of the second inverter 3, and at least one input terminal of the second output module 20 receives the second input signal IN-2.

In addition, the structure of the second output module 20 in FIG. 12 is the same as that in the embodiment of FIG. 6, and the structure of the second output module 20 in FIG. 13 is the same as that in the embodiment of FIG. 7. The structure of the second output module 20 is not further described here.

FIG. 14 is an operating timing diagram of another shift register unit provided by an embodiment of the present application. The timing diagram provided in FIG. 14 is applicable to the shift register unit provided in the embodiment of FIG. 12. Referring to FIGS. 14 and 12, the pulse level of the first input signal IN-1 is a low level, and the pulse level of the first input signal IN-1 at least partially overlaps the low-level period of the first clock signal CK1. During period t21: the first clock signal CK1 provides a low level to control the first submodule 2 to be turned on and write the low level of the first input signal IN-1 to the first node N1, so that the potential of the first node N1 is low. The second inverter 3 is inputted with a low level and outputs a high level, so that the potential of the second node N2 is high. The first inverter 1 is inputted with a high level and outputs a low level, so that the input terminal of the first output module 10 receives a low level. The third inverter 4 in the first output module 10 processes the signal, when the input terminal of the third inverter 4 in the first output module 10 receives a low-level signal, the output terminal of the third inverter 4 in the first output module 10 outputs a high-level signal. At this time, the first output module 10 outputs a high-level signal of the first scan signal sn. During periods t22 and t23, the first node N1 remained at a low level, and the second node N2 remains at a high level, so that the first output module 10 outputs a high-level signal of the first scan signal sn. During period t24, the first clock signal CK1 provides a low level, controlling the first submodule 2 to be turned on and write the high level of the first input signal IN-1 to the first node N1. The potential of the first node N1 is high, and the corresponding potential of the second node N2 is low. The input terminal of the third inverter 4 receives the high-level signal, and the output terminal of the third inverter 4 outputs a low-level signal. During this period, the first output module 10 outputs a low-level signal of the first scan signal sn.

In addition, during period t21, the first inverter 1 outputs a low-level signal, which is written to the third node N3 through the ninth transistor M9 in the submodule 21 and to the fourth node N4 through the ninth transistor M9 in submodule 22. During period t22 when the second clock signal CK2 is a low level, the first inverter 1 continues to output a low-level signal. The third node N3 remains at a low level, controlling the tenth transistor M10 to be turned on and output the low-level signal of the second clock signal CK2. Simultaneously, the potential of the second node N2 is high, controlling the eleventh transistor M11 to be turned off. At this time, the first sub-scan signal sp1 output by the second output module 20 is a low level. The submodule 22 and submodule 21 have the same operating mode. During period t23, when the potential of the third clock signal CK3 is low, the potential of the fourth node N4 is low, controlling the tenth transistor M10 to be turned on and output the low-level signal of the third clock signal CK3. Simultaneously, the potential of the second node N2 is high, controlling the eleventh transistor M11 to be turned off. At this time, the second sub-scan signal sp2 output by the second output module 20 is at a low level.

In the embodiment shown in FIG. 12, at least one control terminal of the second output module 20 is connected to the output terminal of the second inverter 3, and at least one input terminal of the second output module 20 is connected to the output terminal of the first inverter 1. In another embodiment, at least one control terminal of the second output module 20 is connected to the output terminal of the first output module 10, and at least one input terminal of the second output module 20 is connected to the output terminal of the first inverter 1. The remaining structural connections are the same as that in FIG. 12 and are not further illustrated here. The shift register unit provided in this embodiment can also be driven using the timing shown in FIG. 14.

As shown in FIG. 13, the shift register unit further includes a second input module 23. One input terminal of the submodule 21 and one input terminal of the submodule 22 each receive a second input signal IN-2 through the second input module 23. The second input module 23 is configured to write the second input signal IN-2 to one input terminal of the submodule 21 and one input terminal of the submodule 22 each based on the control of the first clock signal CK1.

FIG. 15 is another operating timing diagram of a shift register unit provided by an embodiment of the present application. The timing diagram provided in FIG. 15 can be applied to the shift register unit provided in FIG. 13. Combining FIGS. 15 and 13, the pulse level of the first input signal IN-1 is a high level, while the pulse level of the second input signal IN-2 is a low level. During period t21, the first clock signal CK1 provides a low level, the first submodule 2 is turned on, and the high level of the first input signal IN-1 is written to the first node N1. The first node N1 is at a high potential, the second node N2 is at a low potential, the first inverter 1 outputs a high-level signal, and the third inverter 4 outputs a low-level signal. In other words, the first output module 10 outputs a high-level signal in the first scan signal sn. During periods t22 and t23, the first node N1 remains at a high potential, the second node N2 remains at a low potential, and the first output module 10 outputs a high-level signal in the first scan signal sn. During period t24, the first clock signal CK1 provides a low level, the first submodule 2 is turned on, and the low level of the first input signal IN-1 is written to the first node N1. The first node N1 is at a low potential, the second node N2 is at a high potential, the first inverter 1 outputs a low-level signal, the third inverter 4 outputs a high-level signal, and the first output module 10 begins to output a high-level signal in the first scan signal sn.

Furthermore, the low-level pulse of the second input signal IN-2 at least partially overlaps the low level of the first clock signal CK1. During period t21, the first clock signal CK1 controls the second input module 23 to be turned on, writing the low level of the second input signal IN-2 to the third node N3 of the submodule 21 and the fourth node N4 of submodule 23 each. During period t22, when the second clock signal CK2 is at a low level, the third node N3 remains at a low level, and the first sub-scan signal sp1 output by the second output module 20 is at a low level. During period t23, when the third clock signal CK3 is at a low level, the fourth node N4 remains at a low level, and the second sub-scan signal sp2 output by the second output module 20 is at a low level.

In the embodiment shown in FIG. 13, at least one control terminal of the second output module 20 is connected to the output terminal of the second inverter 3, and at least one input terminal of the second output module 20 receives the second input signal IN-2 via the second input module 23. In another embodiment, at least one control terminal of the second output module 20 is connected to the output terminal of the first output module 10, and at least one input terminal of the second output module 20 receives the second input signal IN-2 via the second input module 23. The connection manner for the remaining structures is the same as that in FIG. 13 and is not further illustrated here. The shift register unit provided in this embodiment can also be driven using the timing diagram shown in FIG. 15.

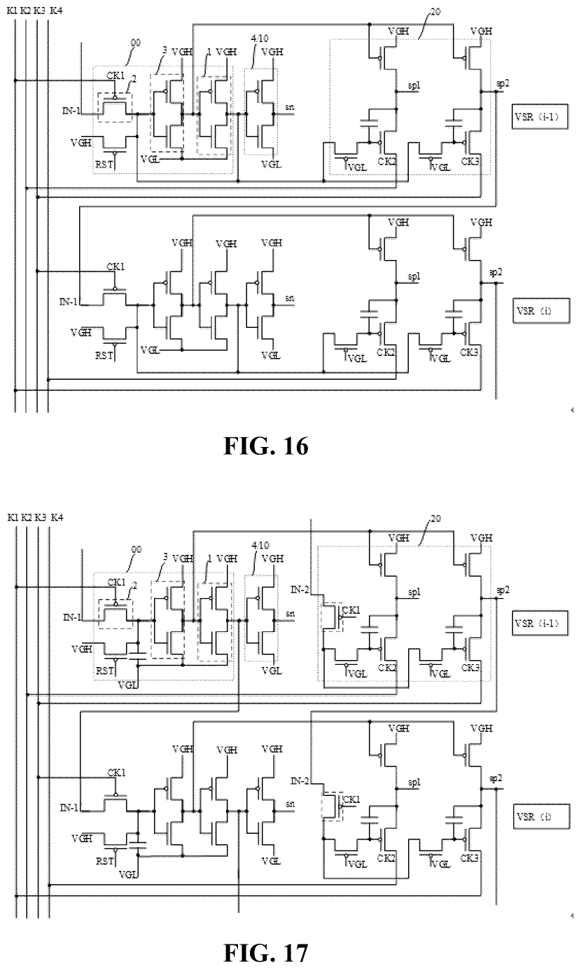

In some embodiments, FIG. 16 is another schematic diagram of a cascade of shift register units provided by an embodiment of the present application. FIG. 16 illustrates a cascade arrangement of the shift register units shown in FIG. 12. In the embodiment of FIG. 12, at least one control terminal of the second output module 20 is connected to the output terminal of the second inverter 3, and at least one input terminal of the second output module 20 is connected to the output terminal of the first inverter 1. In conjunction with the timing diagram in FIG. 14, the pulse level of the first input signal IN-1 is a low level, and the low-level start time of the second sub-scan signal sp2 in the second scan signal is later than the low-level start time of the first sub-scan signal sp1.

FIG. 16 illustrates two cascaded shift register units VSR, namely, the shift register unit VSR(i−1) at the (i−1)^{th} stage and the shift register unit VSR(i) at the i^{th} stage. The input terminal of the first submodule 2 in the shift register unit VSR(i) at the i^{th} stage receives the third scan signal sp2 output by the shift register unit VSR(i−1) at the (i−1)^{th} stage, where i is an integer, i≥2. When driving multiple cascaded shift register units in this embodiment, four clock signal lines are required in the display panel, which are a first clock signal line K1, a second clock signal line K2, a third clock signal line K3, and a fourth clock signal line K4 respectively. The clock signals provided by these four clock signal lines have the same period. For example, i is an even number, and then i−1 is an odd number. For the shift register units at the odd number stages, the first clock signal line K1 provides the first clock signal CK1, the second clock signal line K2 provides the second clock signal CK2, and the third clock signal line K3 provides the third clock signal CK1. For the shift register units at the even number stages, the third clock signal line K3 provides the first clock signal CK1, the fourth clock signal line K4 provides the second clock signal CK2, and the first clock signal line K1 provides the third clock signal CK1.

In other embodiments, FIG. 17 is another schematic diagram of a cascade of shift register units provided by an embodiment of the present application. FIG. 17 illustrates a cascade arrangement of the shift register units in FIG. 13. In the embodiment of FIG. 13, at least one control terminal of the second output module 20 is connected to the output terminal of the second inverter 3, and at least one input terminal of the second output module 20 receives the second input signal IN-2 via the second input module 23. In conjunction with the timing diagram in FIG. 15, the pulse level of the first input signal IN-1 is a high level, the pulse level of the second input signal IN-2 is a low level, and the low-level start time of the second sub-scan signal sp2 in the second scan signal is later than the low-level start time of the first sub-scan signal sp1.

FIG. 17 illustrates two cascaded shift register units VSR, namely, the shift register unit VSR(i−1) at the (i−1)^{th} stage and the shift register unit VSR(i) at the i^{th} stage. The input terminal of the first submodule 2 in the shift register unit VSR(i) at the i^{th} stage is connected to the output terminal of the first inverter 1 in the shift register unit VSR(i−1) at the (i−1)^{th} stage. The input terminal of the second output module 20 in the shift register unit VSR(i) at the i^{th} stage receives the second sub-scan signal sp2 output by the shift register unit VSR(i−1) at the (i−1)^{th} stage, where i is an integer, and i≥2. When driving multiple cascaded shift register units in this embodiment, four clock signal lines need to be provided in the display panel, which are the first clock signal line K1, the second clock signal line K2, the third clock signal line K3, and the fourth clock signal line K4 respectively. The clock signals provided by the four clock signal lines have the same period.

In some embodiments of the present application, the first output module 10 is configured to output a first scan signal based at least on a first level signal of a refresh control signal and a control signal output by the control module 10, and to output a low-level constant voltage signal based at least on a second level signal of the refresh control signal and the control module 10, with one of the first level signal and the second level signal being a high-level signal and the other being a low-level signal. This enables the shift register unit VSR to have two operating modes. For example, in which the shift register unit outputs two second scan signals, in the first mode, the shift register unit VSR outputs the first scan signal sn, the first sub-scan signal sp1, and the second sub-scan signal sp2; in the second mode, the shift register unit VSR outputs a low-level constant voltage signal, the first sub-scan signal sp1, and the second sub-scan signal sp2. Using the shift register units provided in embodiments of the present application, partitioned refresh display can be achieved on a display panel.

For example, a shift register in a display panel includes N stages of shift register units, where Nis an integer. The display panel includes a first refresh frame. In the first refresh frame, the shift register unit at the j^{th} stage to the shift register unit at the q^{th} stage receive the first level signal of the refresh control signal, and the shift register unit at the j^{th} stage to the shift register unit at the q^{th} stage are in the first mode, where j and q are integers, and 1≤j<q<N; the shift register unit at the (q+1)^{th} stage to the shift register unit at the w^{th} stage receive the second level signal of the refresh control signal, and the shift register unit at the (q+1)^{th} stage to the shift register unit at the w^{th} stage are in the second mode, where w is an integer, and q+1<w≤N For example, when the first scan signal sn output by the shift register unit is configured to drive the threshold compensation transistor, the shift register unit VSR can write the data voltage to the gate of the drive transistor when operating in the first mode, and cannot write the data voltage to the gate of the drive transistor when operating in the second mode. Take j=1 and w=N as an example. By setting the refresh control signal, the shift register unit VSR at the first stage to the shift register unit VSR at the q^{th} stage in the cascaded N shift register units VSR operate in the second mode, and the shift register unit at the (q+1)^{th} stage to the shift register unit at the Nth stage operate in the first mode. In this way, in one frame, the upper display region of the display panel does not write the data voltage and does not refresh the image screen, while the lower display region of the display panel writes the data voltage to refresh the image, and the display panel achieves partition refresh.

The following describes an implementation in which the shift register unit has two operating modes.

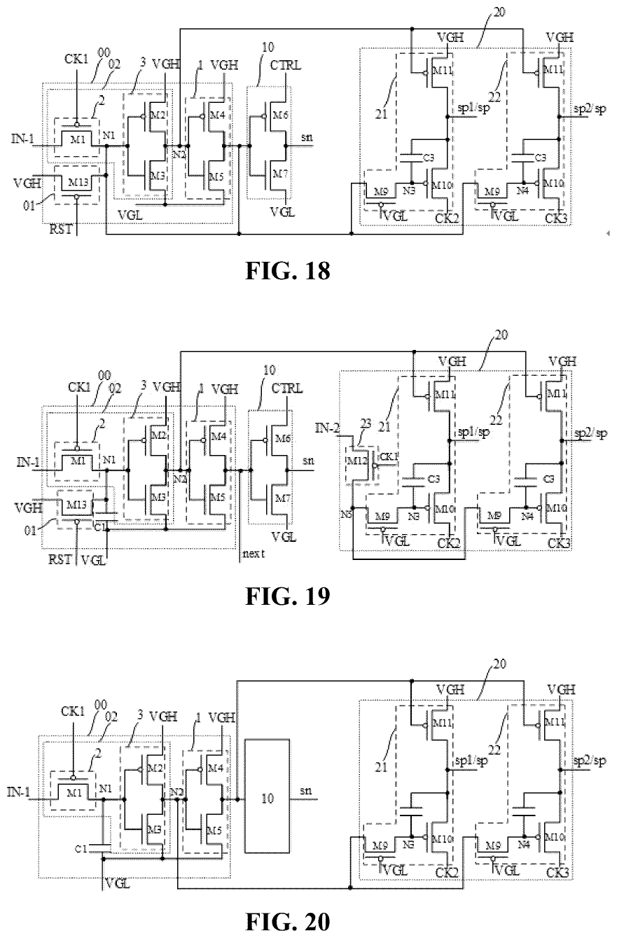

FIG. 18 is another schematic diagram of a shift register unit provided by an embodiment of the present application. As shown in FIG. 18, the control module 00 is configured to output a control signal based on a first input signal IN-1, a first clock signal CK1, a first voltage signal VGL, and a second voltage signal VGH. The control module 00 includes a first input module 02 and a first inverter 1. The input terminal of the first input module 02 receives the first input signal IN-1, and the output terminal of the first input module 02 is connected to the input terminal of the first inverter 1. The first inverter 1 is a CMOS inverter, the ground terminal of the first inverter 1 receives the first voltage signal VGL and the power supply terminal of the first inverter 1 receives the second voltage signal VGH. A first output module 10 and a second output module 20 each are connected to the first inverter 1. In the embodiments of the present application, connection to the input terminal of the first inverter 1 or to the output terminal of the first inverter 1 can be referred to as connection to the first inverter 1. Alternatively, indirect connection to the first inverter 1 through other structures can also be referred to as connection to the first inverter 1. As shown in FIG. 18, the first output module 10 is connected to the output terminal of the first inverter 1, and the second output module 20 is connected to the input terminal of the first inverter 1 and to the output terminal of the first inverter 1. The following embodiments refer to other connection relationships of the first output module 10 and the second output module 20 with the first inverter 1, which may be explained later when relevant features are mentioned.

In the embodiments of the present application, the control module 00 includes an input module 02 and a first inverter 1. The first inverter 1 is capable of inverting the phase of an input signal and outputting it. When the input terminal of the first inverter 1 receives a high-level signal, the output terminal thereof outputs a low-level signal. When the input terminal of the first inverter 1 receives a low-level signal, the output terminal thereof outputs a high-level signal. Two signals with opposite phases are obtained by connecting the input terminal and the output terminal of the first inverter 1 within the same time period. The first output module 10 and the second output module 20 each are connected to the first inverter 1. The first output module 10 and the second output module 20 can each be connected to the input terminal of the first inverter 1 or the output terminal of the first inverter 1 based on their respective structures, so that the first output module 10 outputs the first scan signal sn with a high level as the enable level, and the second output module 20 outputs the second scan signal sp with a low level as the enable level.

FIG. 18 illustrates an optional structure for the control module 00. As shown in FIG. 18, the control module includes a first input module 02 and a first inverter 1. The first input module 02 includes a first submodule 2 and a second inverter 3. The first submodule 2 receives a first input signal IN-1. The output terminal of the first submodule 2 and the input terminal of the second inverter 3 are connected to a first node N1. The output terminal of the second inverter 3 and the input terminal of the first inverter 1 are connected to a second node N2. The output terminal of the first inverter 1 is connected to the input terminal of the second inverter 3. The first inverter 1 and the second inverter 3 form a latch structure, which can stabilize the potential of the first node N1, thereby ensuring the stability of the output signal at the output terminal of the control module 00.

The control module 00 in embodiments of the present application can also have other structures. FIG. 19 is another schematic diagram of a shift register unit provided by an embodiment of the present application. As shown in FIG. 19, the control module 00 includes a first input module 02 and a first inverter 1. The input terminal of the first input module 02 receives a first input signal IN-1, and the output terminal of the first input module 02 is connected to the input terminal of the first inverter 1. The first input module 02 includes a first submodule 2, a second inverter 3, and a first capacitor C1. The first submodule 2 receives the first input signal IN-1. The input terminals of the first submodule 2 and the second inverter 3 are connected to a first node N1. The output terminal of the second inverter 3 and the input terminal of the first inverter 1 are connected to a second node N2. One plate of the first capacitor C1 is connected to the input terminal of the second inverter 3, and the other plate receives a first voltage signal VGL. A first output module 10 is connected to the output terminal of the first inverter 1, and a second output module 20 is connected to the input terminal of the first inverter 1. The second output module 20 further receives a second input signal IN-2. In this embodiment, the first capacitor C1 is configured to stabilize the potential of the first node N1, ensuring the stability of the output signal at the output terminal of the control module 00.

As shown in FIGS. 18 and 19, the first submodule 2 includes a first transistor M1. The first transistor M1 is a p-type transistor. The control terminal of the first transistor M1 receives the first clock signal CK1, the first terminal of the first transistor M1 receives the first input signal IN-1, and the second terminal of the first transistor M1 is connected to the input terminal of the second inverter 3.

The second inverter 2 includes a second transistor M2 and a third transistor M3. The second transistor M2 is a p-type transistor, and the third transistor M3 is an n-type transistor. The control terminal of the second transistor M2 and the control terminal of the third transistor M3 serve as the input terminal of the second inverter 2. The first terminal of the third transistor M3 receives the first voltage signal VGL, and the first terminal of the second transistor M2 receives the second voltage signal VGH. The second terminal of the second transistor M2 and the second terminal of the third transistor M3 serve as the output terminal of the second inverter 2.

The first inverter 1 includes a fourth transistor M4 and a fifth transistor M5. The fourth transistor M4 is a p-type transistor, and the fifth transistor M5 is an n-type transistor. The control terminals of the fourth transistor M4 and the fifth transistor M5 serve as input terminal of the first inverter 1. The first terminal of the fifth transistor M5 receives the first voltage signal VGL, and the first terminal of the fourth transistor M4 receives the second voltage signal VGH. The second terminal of the fourth transistor M4 and the second terminal of the fifth transistor M45 serve as output terminal of the first inverter 1.

As shown in FIG. 18, the control module 00 further includes a reset submodule 01. The reset submodule 01 is configured to write the second voltage signal VGH to the first node N1 under the control of a reset control signal RST, so as to reset the first node N1. Specifically, the reset submodule 01 includes a thirteenth transistor M13. Optionally, the thirteenth transistor M13 is a p-type transistor, with a control terminal receiving the reset control signal RST, a first terminal receiving the second voltage signal VGH, and a second terminal connected to the first node N1.

In the embodiments of the present application, a first output module 10 and a second output module 20 each are connected to the first inverter 1 in the control module 00. The connection modes between the two output modules and the first inverter 1 can be implemented in a variety of ways as follows.

In some embodiments, as shown in FIG. 18, at least one control terminal of the first output module 10 is connected to the output terminal of the first inverter 1; at least one control terminal of the second output module 20 is connected to the input terminal of the first inverter 1; and at least one input terminal of the second output module 20 is connected to the output terminal of the first inverter 1. This embodiment utilizes a signal at the output terminal of the first inverter 1 to control the first output module 10 to output the first scan signal sn, and utilizes signals at both the output terminal and input terminal of the first inverter 1 to control the second output module 20 to output the second scan signal sp.

In some embodiments, as shown in FIG. 19, at least one control terminal of the first output module 10 is connected to the output terminal of the first inverter 1; at least one control terminal of the second output module 20 is connected to the input terminal of the first inverter 1, and at least one input terminal of the second output module 20 receives the second input signal IN-2. This embodiment utilizes the signal at the output terminal of the first inverter 1 to control the first output module 10 to output the first scan signal sn, and utilizes the signal at the input terminal of the first inverter 1 and the second input signal IN-2 to control the second output module 20 to output the second scan signal sp.

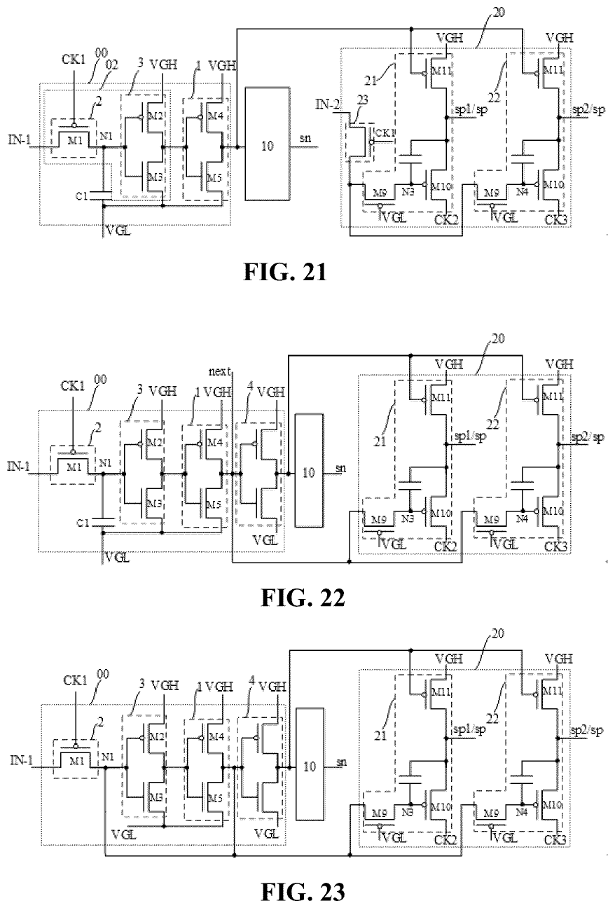

In some embodiments, FIG. 20 is another schematic diagram of a shift register unit provided by an embodiment of the present application. As shown in FIG. 20, at least one control terminal of the first output module 10 is connected to the output terminal of the first inverter 1; at least one control terminal of the second output module 20 is connected to the output terminal of the first inverter 1; and at least one input terminal of the second output module 20 is connected to the input terminal of the first inverter 1. This embodiment utilizes the signal at the output terminal of the first inverter 1 to control the first output module 10 to output the first scan signal sn, and utilizes the signal at the input terminal and output terminal of the first inverter 1 to control the second output module 20 to output the second scan signal sp.

In some embodiments, FIG. 21 is another schematic diagram of a shift register unit provided by an embodiment of the present application. As shown in FIG. 21, at least one control terminal of the first output module 10 is connected to the output terminal of the first inverter 1; at least one control terminal of the second output module 20 is connected to the output terminal of the first inverter 1; and at least one input terminal of the second output module 20 receives the second input signal IN-2. This embodiment utilizes the signal at the output terminal of the first inverter 1 to control the first output module 10 to output the first scan signal sn, and utilizes the signal at the output terminal of the first inverter 1 and the second input signal IN-2 to control the second output module 20 to output the second scan signal sp.

In other embodiments, FIG. 22 is another schematic diagram of a shift register unit provided by an embodiment of the present application, and FIG. 23 is another schematic diagram of a shift register unit provided by an embodiment of the present application. As shown in FIGS. 22 and 23, the control module 00 further includes a third inverter 4, the input terminal of the third inverter 4 is connected to the output terminal of the first inverter 1. At least one control terminal of the first output module 10 is connected to the output terminal of the third inverter 4; that is, the third inverter 4 is connected to the output terminal of the first inverter 1 through the third inverter 4. At least one control terminal of the second output module 20 is connected to the output terminal of the third inverter 4, and at least one input terminal of the second output module 20 is connected to the output terminal of the first inverter 1. The third inverter 4 is a CMOS inverter. This embodiment utilizes the signal at the output terminal of the third inverter 4 to control the first output module 10 to output the first scan signal sn, and utilizes the signal at the output terminal of the third inverter 4 and the signal at the output terminal of the first inverter 1 to control the second output module 20 to output the second scan signal sp.

In the embodiment of FIG. 22, a third inverter 4 is added to the control module 00, and a first output module 10 is connected to the output terminal of the third inverter 4. In applications, when the pulse level of the first input signal IN-1 is a low level, the first node N1 connecting the first submodule 2 and the second inverter 3 is in a low-level state for most of the time, thereby mitigating the impact on power consumption caused by the third transistor M3 in the second inverter 3 failing to be turned off when the first node N1 is in a high-level state for most of the time, which would otherwise lead to a short circuit at the high/low voltage receiving terminal at the location of the second inverter 3. In this embodiment, the signal at the output terminal of the first inverter 1 can serve as the transfer-stage signal next. In a cascade connection, the output terminal of the first inverter 1 is connected to the input terminal of the first submodule 2 in the next-stage shift register unit.

The difference between FIG. 22 and FIG. 23 is that a first capacitor C1 is provided in FIG. 22, one plate of the first capacitor C1 is connected to the first node N1, and the other plate receives the first voltage signal VGL. In contrast, the first capacitor C1 is not provided in FIG. 23 to connect the first node N1 to the output terminal of the first inverter 1, so that the first inverter 1 and the second inverter 3 form a latch structure. In the embodiment of FIG. 23, the pulse level of the first input signal IN-1 is a low level. When cascading, the input terminal of the first submodule 2 in the shift register unit receives a second scan signal output by the shift register unit at the previous stage.

The previous embodiments of FIGS. 18 and 19 illustrate optional structures of the control module 00. The following illustrates optional structures of the second output module 20 in embodiments of the present application.

In some embodiments of the present application, the second output module 20 is configured to output the second scan signal sp based on the first voltage signal VGL, the second voltage signal VGH, at least one clock signal, and the control signal output by the control module 00. As in the embodiments of FIGS. 18 and 20, the control signal output by the control module 00 received by the second output module 20 includes the signal from the output terminal of the first inverter 1 and the signal from the input terminal of the first inverter 1. As shown in the embodiments of FIGS. 22 and 23, the control signal that is output by the control module 00 and received by the second output module 20 includes the signal from the output terminal of the first inverter 1 and the signal from the output terminal of the third inverter 4.

In some embodiments of the present application, the second output module 20 is configured to output the second scan signal sp based on the first voltage signal VGL, the second voltage signal VGH, at least one clock signal, the control signal output by the control module 00, and the second input signal IN-2. As shown in the embodiment of FIG. 19, the control signal that is output by the control module 00 and received by the second output module 20 includes the signal from the input terminal of the first inverter 1. As shown in the embodiment of FIG. 21, the control signal that is output by the control module 00 and received by the second output module 20 includes the signal from the output terminal of the first inverter 1.

In other embodiments of the present application, the second output module 20 is configured to output the second scan signal sp based on the first voltage signal VGL, the second voltage signal VGH, at least one clock signal, as well as the control signal output by the control module 00 and the signal output by the first output module 10, or the output signal of the first output module 10 and the second input signal IN-2. Refer to the relevant descriptions of the embodiments in FIGS. 6, 7, 12, and 13 above.

In this embodiment of the present application, the second output module 20 includes at least one submodule. Each submodule is configured to output at least one second scan signal sp based at least on the first voltage signal VGL, the second voltage signal VGH, and based at least on the control signal output by the control module 00 and the signal output by the first output module 10 (as in the embodiment of FIG. 6), or the output signal of the first output module 10 and the second input signal IN-2 (as in the embodiment of FIG. 7), or the control signal output by the control module 00 (as in the embodiments of FIG. 12, FIG. 18, FIG. 20, FIG. 22, and FIG. 23), or the control signal output by the control module 00 and the second input signal IN-2 (as in the embodiments of FIG. 13, FIG. 19, and FIG. 21).

Taking for example that the second output module 20 includes the submodule 21 and the submodule 22, in the embodiments of the present application, at least one control terminal of the submodule 21 and at least one control terminal of the submodule 22 are connected to the control module 00 or first output module 10; at least one input terminal of the submodule 21 and at least one input terminal of the submodule 22 are connected to the control module 00 or to the first output module 10, or receive the second input signal IN-2. In the embodiment of FIG. 6, at least one control terminal of the submodule 21 and at least one control terminal of the submodule 22 are connected to the control module 00 (specifically, connected to the output terminal of the second inverter 3), and at least one input terminal of the submodule 21 and at least one input terminal of submodule 22 are connected to the first output module 10 (specifically, connected to the output terminal of the first inverter 1 in FIG. 6). In the embodiment of FIG. 18, at least one control terminal of the submodule 21 and at least one control terminal of submodule 22 are connected to the control module 00 (specifically, connected to the input terminal of the first inverter 1), and at least one input terminal of the submodule 21 and at least one input terminal of submodule 22 are connected to control module 00 (specifically, connected to the output terminal of the first inverter 1). In the embodiment of FIG. 19, at least one control terminal of the submodule 21 and at least one control terminal of submodule 22 are connected to the control module 00 (specifically, connected to the input terminal of first inverter 1), and at least one input terminal of the submodule 21 and at least one input terminal of submodule 22 receive second input signal IN-2. The connection relationships of submodule 21 and the submodule 22 with control module 00 and/or first output module 10 in other embodiments can be understood by reference and are not further described here.

Taking the embodiment of FIG. 18 as an example, as shown in FIG. 18, the submodule 21 and the submodule 22 in the second output module 20 each include a ninth transistor M9, a tenth transistor M10, and an eleventh transistor M11. The control terminal of the ninth transistor M9 receives the first voltage signal VGL, the first terminal of the ninth transistor M9 is connected to the output terminal of the first inverter 1 in the control module 00, the second terminal of the ninth transistor M9 is connected to the control terminal of the tenth transistor M10, the first terminal of the tenth transistor M10 receives the second clock signal CK2, the control terminal of the eleventh transistor M11 is connected to the input terminal of the first inverter 1 in the control module 00, and the first terminal of the eleventh transistor M11 receives the second voltage signal VGH. In the submodule 21, the output terminal of the tenth transistor M10 and the output terminal of the eleventh transistor M11 are connected to the output terminal of the submodule 21. In the submodule 22, the output terminal of the tenth transistor M10 and the output terminal of the eleventh transistor M11 are connected to the output terminal of the submodule 22.

In addition, the submodule 21 and the submodule 22 each include a third capacitor C3. In the submodule 21, the ninth transistor M9 and the tenth transistor M10 are connected to a third node N3. One plate of the third capacitor C3 is connected to the third node N3, and the other plate is connected to the output terminal of the submodule 21. In the submodule 22, the ninth transistor M9 and the tenth transistor M10 are connected to a fourth node N4. One plate of the third capacitor C3 is connected to the fourth node N4, and the other plate is connected to the output terminal of the submodule 22.

In some embodiments, as shown in FIG. 19, one input terminal of the submodule 21 and one input terminal of the submodule 22 each receive a second input signal IN-2 via a second input module 23. The second input module 23 is configured to write the second input signal IN-2 to one input terminal of the submodule 21 and one input terminal of the submodule 22 each based on the control of the first clock signal CK1. In this embodiment, the operation of the shift register unit requires a first input signal IN-1 and a second input signal IN-2. The second output signal IN-2 controls the second output module 20 to output the second scan signal sp1 and the third scan signal sp2, so that the output signals of the second output module 20 are not affected by the number of pulses of the first input signal IN-1. When the first input signal IN-1 is multi-pulsed, the first scan signal sn output by the first output module 10 can be multi-pulsed without affecting the output of the second output module 20. The operating mode of the second input module 23 and the solution of the first scan signal sn being multiple pulses will be described in the following related embodiments.

Specifically, as shown in FIG. 19, the second input module 23 includes a twelfth transistor M12. The control terminal of the twelfth transistor M12 receives the first clock signal CK1, the input terminal of the twelfth transistor M12 receives the second input signal IN-2, and the output terminals of the twelfth transistor M12 are connected to the submodule 21 and the submodule 22 respectively.

The above embodiments have illustrated the structures of the control module 00 and the second output module 20. The following examples illustrate the function and structure of the first output module 10 in the embodiments of the present application, and describe the operating process of the shift register unit VSR in conjunction with some specific embodiments.

In some embodiments, one port of the first output module 10 receives the refresh control signal CTRL. In specific embodiments, the port in the first output module 10 that receives the refresh control signal CTRL can be a control terminal, such as a gate of the transistor, or an input terminal, such as a source or a drain of the transistor. The first output module 10 is configured to output a first scan signal sn based at least on the control signal output by the control module 00 and a first level signal of the refresh control signal CTRL, and to output a low-level constant voltage signal based at least on the control signal output by the control module 00 and a second level signal of the refresh control signal CTRL; one of the first level signal and the second level signal is a high-level signal, and the other is a low-level signal. In this embodiment, the first output module 10 can output the low-level constant voltage signal or the first scan signal sn, based on the level of the refresh control signal CTRL. In applications, by configuring the refresh control signal CTRL, the shift register unit can have two operating modes. In the first mode, the first output module 10 outputs a first scan signal sn, and the second output module 20 outputs a second scan signal sp. In the second mode, the first output module 10 outputs a low-level constant voltage signal, and the second output module 20 outputs a second scan signal sp. For example, during a display process of the a display panel in one frame, the shift register units VSR at the 1st stage to k^{th} stage in the cascaded N shift register units VSR are configured to operate in the second mode, and the shift register units VSR at the (k+1)^{th} stage to Nth stage operate in the first mode, where N and k are both positive integers, and k is less than N. In this way, the upper display region of the display panel does not have data voltages written and the image is not refreshed, while the lower display region can have data voltages written and the image refreshed, thereby achieving partitioned refresh on the display panel.

In some embodiments, as shown in FIGS. 18 and 19, the first output module 10 includes a sixth transistor M6 and a seventh transistor M7. The sixth transistor M6 is a p-type transistor, and the seventh transistor M7 is an n-type transistor. The control terminal of the sixth transistor M6 and the control terminal of the seventh transistor M7 each are connected to the output terminal of the first inverter 1. The first terminal of the sixth transistor M6 receives the refresh control signal CTRL, and the first terminal of the seventh transistor M7 receives the first voltage signal VGL. The second terminal of the sixth transistor M6 and the second terminal of the seventh transistor M7 each are connected to the output terminal of the first output module 10. The first level signal of the refresh control signal CTRL is a high-level signal, and the second level signal is a low-level signal. That is, when the refresh control signal CTRL is a high-level signal, the shift register unit operates in the first mode, and when the refresh control signal CTRL is a low-level signal, the shift register unit operates in the second mode.

In addition, in the embodiments of FIGS. 18 and 19, the seventh transistor M7 is a transistor directly connected to the output terminal of the first output module 10, and the first voltage signal VGL received by its first terminal can be provided by a separate signal line. That is, the first terminal of the seventh transistor M7 and the first terminal of the fifth transistor M5 both receive the first voltage signal VGL, but the two transistors are connected to different signal lines. This configuration ensures the signal output performance of the first output module 10.

An embodiment of the present application further provides another method for driving the display panel that can be used to drive the display panel. The display panel includes the shift register units in the embodiment of FIG. 18. The driving method includes: providing a first input signal IN-1, a first clock signal CK1, a first voltage signal VGL, and a second voltage signal VGH to a control module 00, and controlling the control module 00 to output a control signal; controlling the first output module 10 to begin outputting a high-level signal of the first scan signal sn based at least on the control signal output by the control module 00 during a period when a pulse of the first input signal IN-1 overlaps a first low level of the first clock signal CK1, and controlling the first output module 10 to stop outputting a high-level signal of the first scan signal sn based at least on the control signal output by the control module 00 during a period when a non-pulse of the first input signal IN-1 overlaps a second low level of the first clock signal CK1. The second low level is the sth pulse signal after the first low level, where s is a positive integer. During periods when the first clock signal CK1 provides a first low level and a second low level, the second output module 20 is controlled to output at least one low-level signal of the second scan signal sp based at least on the control signal output by the control module 00 and/or the signal output by the first output module 10.

In addition, in the driving method provided by an embodiment of the present application, during periods when the first clock signal CK1 provides a first low level (i.e. the first low level that overlaps a high-level pulse of the first input signal IN-1) and a second low level, the second output module 20 is controlled to output at least one low-level signal of the second scan signal sp based on at least one clock signal. The low-level period of the clock signal received by the second output module 20 corresponds to the low-level period of the second scan signal sp. For example, the second output module 20 outputs two second scan signals sp, at least two clock signals need to be input to control the second output module 20.

In addition, in an embodiment of the present application, the controlling the first output module 10 to output the first scan signal sn based at least on the control signal output by the control module 00 includes: controlling the first output module 10 to output the first scan signal sn based at least on the first level signal of the refresh control signal CTRL and the control signal output by the control module 00. The driving method further includes: controlling the first output module 10 to output a low-level constant voltage signal based at least on the second level signal of the refresh control signal CTRL and the control signal output by the control module 00. One of the first level signal and the second level signal is a high-level signal, and the other is a low-level signal. The driving method provided in this embodiment of the present application enables the shift register unit to have two operating modes, thereby realizing a partitioned refresh function for the display panel. The driving method provided in this embodiment is applicable to an embodiment in which the first output module 10 receives the refresh control signal CTRL. The driving method can be understood in conjunction with the following operating timing diagram.

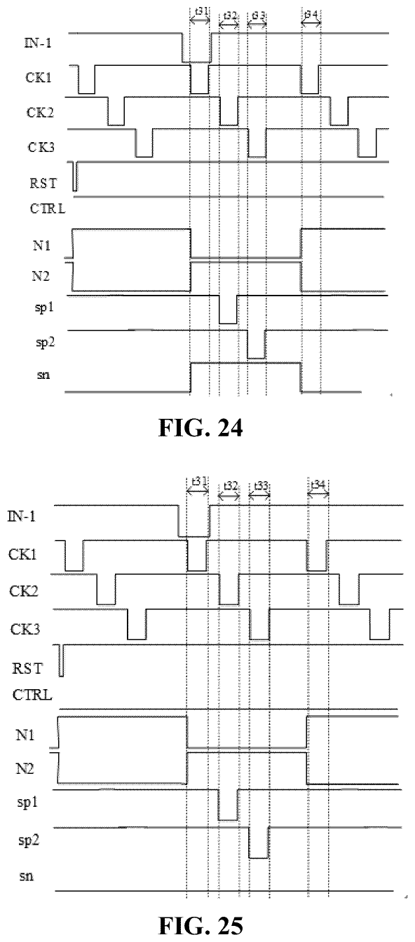

FIG. 24 is another operating timing diagram of a shift register unit provided by an embodiment of the present application. The timing diagram provided in FIG. 24 can be applied to the shift register unit provided in FIG. 18. In the timing diagram of FIG. 24, the refresh control signal CTRL is a high-level signal, and the pulse level of the first input signal IN-1 is a low-level. Combining FIGS. 18 and 24, the shift register unit operates as follows.

During period t31, the first clock signal CK1 is at a low level, controlling the first transistor M1 in the first submodule 2 to be turned on. The low level of the first input signal IN-1 is written to the first node N1, and the first node N1 is at a low potential. The input terminal of the second inverter 3 composed of the second transistor M2 and the third transistor M3 receives a low-level signal, and the output terminal outputs a high-level signal, and the second node N2 is at a high potential. The first inverter 1 composed of the fourth transistor M4 and the fifth transistor M5 is input with a high-level signal and outputs a low-level signal, and the control terminal of the first output module 10 receives the low-level signal. The low-level signal controls the sixth transistor M6 to be turned on and provides the high level of the refresh control signal CTRL to the output terminal of the first output module 10. During this period, the output terminal of the first output module 10 outputs the high level of the first scan signal sn. Furthermore, when the input terminal of the first inverter 1 is at a high level and the output terminal of the first inverter 1 is at a low level, the high level at the input terminal of the first inverter 1 controls the eleventh transistors M11 in the submodule 21 and the submodule 22 to be turned off. The low level at the output terminal of the first inverter 1 is written to the third node N3 and the fourth node N4 via each of the ninth transistors M9 in the submodule 21 and the submodule 22. The tenth transistors M10 in the submodule 21 and the submodule 22 are turned on. The tenth transistor M10 in the submodule 21 is turned on, providing the high level of the second clock signal CK2 to the output terminal of the submodule 21, and the submodule 21 outputs a high-level signal of the first sub-scan signal sp1. The tenth transistor M10 in the submodule 22 is turned on, providing the high level of the third clock signal CK3 to the output terminal of the submodule 22, and the submodule 22 outputs a high-level signal of the second sub-scan signal sp2.

During period t32, the first clock signal CK1 is at a high level, the first transistor M1 is turned off, the first node N1 remains at a low potential, and the second node N2 remains at a high potential. The input terminal of the first inverter 1 is at a high potential and the output terminal of the first inverter 1 is at a low potential. The output terminal of the first output module 10 outputs a high-level signal of the first scan signal sn. In the second submodule 21, the eleventh transistor M11 is turned off, the third node N3 remains at a low potential, and the tenth transistor 10 is controlled to be turned on, providing the low level of the second clock signal CK2 to the output terminal of the second submodule 21. The second submodule 21 outputs a low-level signal of the second scan signal sp1. In the third submodule 22, the eleventh transistor M11 is turned off, the fourth node N4 remains at a low potential, and the tenth transistor 10 is controlled to be turned on. The third clock signal CK3 is at a high-level signal, and the third submodule 22 outputs a high-level signal of the third scan signal sp2.

During period t33, the first clock signal CK1 is at a high level, the first transistor M1 is turned off, the first node N1 remains at a low potential, and the second node N2 remains at a high potential. The input terminal of the first inverter 1 is at a high potential and the output terminal is at a low potential. The output terminal of the first output module 10 outputs a high-level signal of the first scan signal sn. In the second submodule 21, the eleventh transistor M11 is turned off, and the third node N3 remains at a low potential, controlling the tenth transistor 10 to be turned on. The second clock signal CK2 is at a high level, and the second submodule 21 outputs a high-level signal of the second scan signal sp1. In the third submodule 22, the eleventh transistor M11 is turned off, and the fourth node N4 remains at a low potential, controlling the tenth transistor 10 to be turned on. The third clock signal CK3 is a low-level signal, and the third submodule 22 outputs a low-level signal of the third scan signal sp2.

During period t34, the first clock signal CK1 is at a low level, controlling the first transistor M1 to be turned on, a high-level signal of the first input signal IN-1 is written to the first node N1, so that the first node N1 is at a high potential and the second node N2 is at a low level. The input terminal of the first inverter 1 is at a low potential, and the output terminal of the first inverter 1 is at a high potential. The high-level signal at the output terminal of the first inverter 1 controls the sixth transistor M6 in the first output module 10 to be turned off and the seventh transistor M7 in the first output module 10 to be turned on. The seventh transistor M7 provides the low-level signal of the first voltage signal VGL to the output terminal of the first output module 10, and the output terminal of the first output module 10 outputs the low-level signal of the first scan signal sn. The high-level signal at the second node N2 controls the eleventh transistors M11 in the second submodule 21 and the third submodule 22 to be turned on. The output terminal of the first inverter 1 is at the high potential, so that the third node N3 in the second submodule 21 is at a high potential to control the tenth transistor M10 to be turned off, and the fourth node N4 in the third submodule 22 is at a high potential to control the tenth transistor M10 to be turned off. The eleventh transistor M11 in the second submodule 21 is turned on, providing a high-level signal of the second voltage signal VGH to the output terminal of the second submodule 21. The second submodule 21 outputs a high-level signal of the second scan signal sp1. The eleventh transistor M11 in the third submodule 22 is turned on, providing a high-level signal of the second voltage signal VGH to the output terminal of the third submodule 22. The third submodule 22 outputs a high-level signal of the third scan signal sp2.

When being driven using the timing shown in FIG. 24, the shift register unit outputs the first scan signal sn, the second scan signal sp1, and the third scan signal sp2.

FIG. 25 is another operating timing diagram of a shift register unit provided by an embodiment of the present application. The timing diagram shown in FIG. 25 can also be applied to the shift register unit shown in FIG. 18. In the timing shown in FIG. 25, the refresh control signal CTRL is a low-level signal, and the pulse level of the first input signal IN-1 is a low level. Combining FIGS. 18 and 25, the shift register unit operates as follows.

During period t31, the first clock signal CK1 is at a low level, controlling the first transistor M1 in the first submodule 2 to be turned on. The low level of the first input signal IN-1 is written to the first node N1, and the first node N1 is at a low potential. The input terminal of the second inverter 3 composed of the second transistor M2 and the third transistor M3 receives a low-level signal, the output terminal of the second inverter 3 outputs a high-level signal, and the second node N2 is at a high potential. The first inverter 1 composed of the fourth transistor M4 and the fifth transistor M5 is input with a high-level signal and outputs a low-level signal. The control terminal of the first output module 10 receives a low-level signal to control the sixth transistor M6 to be turned on and the seventh transistor M7 to be turned off. The sixth transistor M6 is turned on, providing the low level of the refresh control signal CTRL to the output terminal of the first output module 10, and the output terminal of the first output module 10 outputs a low-level signal. Furthermore, during this period, the high level at the input terminal of the first inverter 1 controls the eleventh transistors M11 in the second submodule 21 and the third submodule 22 to be turned off. The low level at the output terminal of the first inverter 1 is written to the third node N3 and the fourth node N4 via each of the ninth transistors M9 in the second submodule 21 and the third submodule 22. The tenth transistors M10 in the second submodule 21 and the third submodule 22 are turned on. The second submodule 21 outputs a high-level signal of the second scan signal sp1, and the third submodule 22 outputs a high-level signal of the third scan signal sp2.

During period t32, the first clock signal CK1 is at a high level, the first transistor M1 is turned off, the first node N1 remains at a low potential, and the second node N2 remains at a high potential. The input terminal of the first inverter 1 is at a high potential, and the output terminal is at a low potential. The sixth transistor M6 in the first output module 10 is turned on, and the refresh control signal CTRL is at a low level, so that the output terminal of the first output module 10 outputs a low-level signal. In the submodule 21, the eleventh transistor M11 is turned off, and the third node N3 remains at a low potential, controlling the tenth transistor 10 to be turned on and providing the low level of the second clock signal CK2 to the output terminal of the submodule 21. The submodule 21 outputs a low-level signal of the first sub-scan signal sp1. In the submodule 22, the eleventh transistor M11 is turned off, the fourth node N4 remains at a low potential to control the tenth transistor 10 to be turned on, the third clock signal CK3 is a high-level signal, and submodule 22 outputs a high-level signal of the second sub-scan signal sp2.

During period t33, the first clock signal CK1 is at a high level, turning off the first transistor M1. The first node N1 remains at a low potential, and the second node N2 remains at a high potential. The input terminal of the first inverter 1 is at a high potential, and the output terminal is at a low potential. The output terminal of the first output module 10 continues to output a low-level signal. In the submodule 21, the third node N3 remains at a low potential, controlling the tenth transistor 10 to be turned on. The second clock signal CK2 is at a high level, and the submodule 21 outputs a high-level signal of the first sub-scan signal sp1. In the submodule 22, the fourth node N4 remains at a low potential, controlling the tenth transistor 10 to be turned on. The third clock signal CK3 is a low-level signal, and the submodule 22 outputs a low-level signal of the second sub-scan signal sp2.

During period t34, the first clock signal CK1 is at a low level, controlling the first transistor M1 to be turned on. The high-level signal of the first input signal IN-1 is written to the first node N1. The first node N1 is at a high potential, and the second node N2 is at a low potential. The input terminal of the first inverter 1 is at a low potential, and the output terminal of the first inverter 1 is at a high potential. In the first output module 10, the sixth transistor M6 is turned off and the seventh transistor M7 is turned on. The seventh transistor M7 provides a low-level signal of the first voltage signal VGL to the output terminal of the first output module 10, the output terminal of the first output module 10 outputs a low-level signal. The operating states of the submodule 21 and the submodule 22 in this period are the same as those in period t31. The submodule 21 outputs a high-level signal of the first sub-scan signal sp1, and the submodule 22 outputs a high-level signal of the second sub-scan signal sp2.

When being driven using the timing shown in FIG. 25, the shift register unit outputs a low-level constant voltage signal, the first sub-scan signal sp1, and the second sub-scan signal sp2.

The shift register unit provided in the embodiment of FIG. 18 operates in the first mode when being driven using the signal timing shown in FIG. 24, and operates in the second mode when being driven using the signal timing shown in FIG. 25. When the refresh control signal CTRL is a high-level signal, the first output module 10 outputs the first scan signal sn, and the shift register unit operates in the first mode and outputs the first scan signal sn and the second scan signal sp. When the refresh control signal CTRL is a low-level signal, the first output module 10 outputs a low-level constant voltage signal. The shift register unit operates in the second mode and outputs a low-level constant voltage signal and a second scan signal sp.

In the embodiment of FIG. 18, the input module 02 in the control module 00 includes a first submodule 2 and a second inverter 3. The first submodule 2 receives the first input signal IN-1. The output terminal of the first submodule 2 and the input terminal of the second inverter 3 are connected to a first node N1. The output terminal of the second inverter 3 and the input terminal of the first inverter 1 are connected to a second node N2. The output terminal of the first inverter 1 is connected to the input terminal of the second inverter 3. The first inverter 1 and the second inverter 3 form a latch structure. The first output module 10 is connected to the output terminal of the first inverter 1, and the second output module 20 is connected to the output terminal and input terminal of the first inverter 1. In applications, the shift register units can be cascaded in the following manner.

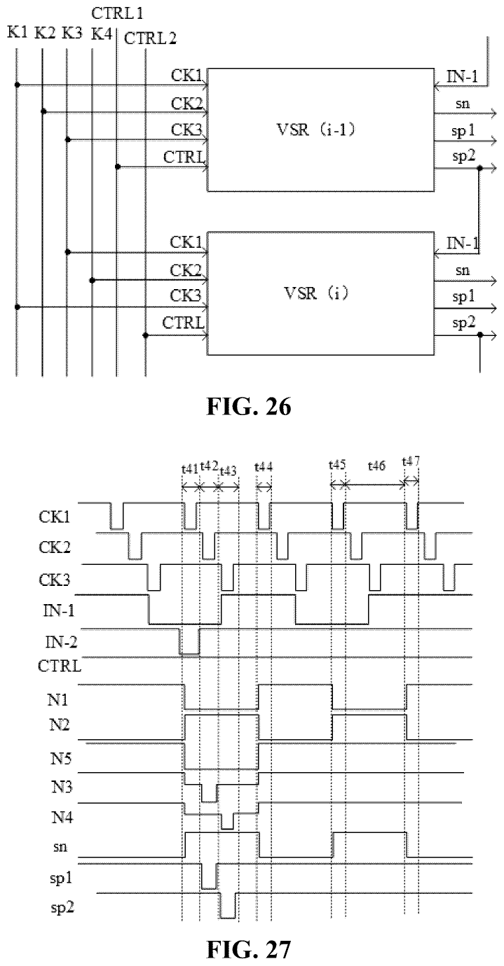

FIG. 26 is another schematic diagram of a cascade of shift register units provided by an embodiment of the present application. FIG. 26 illustrates a cascaded arrangement of the shift register units in FIG. 18. In conjunction with FIGS. 24 and 25, the pulse level of the first input signal IN-1 required by the shift register unit during operation is a low level, a low-level start time of the second sub-scan signal sp2 in the second scan signal sp is later than a low-level start time of the first sub-scan signal sp1. FIG. 26 illustrates two cascaded shift register units VSR, which are the shift register unit VSR(i−1) at the (i−1)^{th} stage and the shift register unit VSR(i) at the i^{th} stage respectively. The input terminal of the first submodule 2 (referring to the schematic diagram of FIG. 18) in the shift register unit VSR(i) at the i^{th} stage receives the second sub-scan signal sp2 output by the shift register unit VSR(i−1) at the (i−1)^{th} stage, where i is an integer, and i≥2. That is, the first input signal IN-1 received by the shift register unit at the current stage is the second sub-scan signal sp2 output by the shift register unit at the previous stage.

When driving the multiple cascaded shift register units shown in FIG. 26, the display panel requires four clock signal lines and two refresh control lines. The clock signal lines are a first clock signal line K1, a second clock signal line K2, a third clock signal line K3, and a fourth clock signal line K4. The clock signals provided by the four clock signal lines have the same period. The two refresh control lines are a first refresh control line CTRL1 and a second refresh control line CTRL2. For example, i is an even number, and then i−1 is an odd number. For the shift register units at the odd number stages, the first clock signal line K1 provides the first clock signal CK1, the second clock signal line K2 provides the second clock signal CK2, and the third clock signal line K3 provides the third clock signal CK1. For the shift register units at the even number stages, the third clock signal line K3 provides the first clock signal CK1, the fourth clock signal line K4 provides the second clock signal CK2, and the first clock signal line K1 provides the third clock signal CK1. The first output modules 10 in the shift register units at the odd number stages are connected to the first refresh control line CTRL1, and the first output modules 10 in the shift register units at the even number stages are connected to the second refresh control line CTRL2.

For example, in the first refresh frame of a display panel, in which the upper display region refreshes image data while the lower display region does not refresh image, the multiple shift register units in the upper display region are driven in the first mode, while the multiple shift register units in the lower display region are driven in the second mode. Combining the timing diagrams of FIGS. 24 and 25, the shift register units operate in the first mode when the refresh control signal CTRL is at a high level, and the shift register units operate in the second mode when the refresh control signal CTRL is at a low level. It can be understood that the first refresh frame of the display panel can be achieved by controlling the signal from the first refresh control line CTRL1 and the second refresh control line CTRL2 to initially be at a high level and then transition to a low level for a certain time period.

In the embodiment of FIG. 19, the shift register unit further includes a second input module 23 that receives a second input signal IN-2. A second output module 20 is connected to the control module 00. The driving method provided in the embodiments of the present application includes controlling the second output module 20 to output at least one low-level signal of the second scan signal based at least on the second input signal IN-2 and a control signal output by the control module 00. The second input signal IN-2 is written to the second output module 20 during a period in which the first clock signal CK1 provides a first low level (i.e., the first low-level period in the first clock signal CK1 that overlaps a pulse of the first input signal IN-1). The driving method provided in this embodiment is applicable to embodiments of the present application that include a second input module 23.

An embodiment of the present application also provides a signal timing that can be used to drive the shift register unit shown in FIG. 19. FIG. 27 is another operating timing diagram of a shift register unit provided by an embodiment of the present application. In the timing diagram of FIG. 27, the refresh control signal CTRL is a high-level signal, the pulse level of the first input signal IN-1 is a low level, the pulse level of the second input signal IN-2 is a low level, and the first input signal IN-1 includes two pulses. Combining FIGS. 19 and 27, the shift register unit operates as follows.

During period t41, the first clock signal CK1 is at a low level, controlling the first transistor M1 to be turned on and writing the low level of the first input signal IN-1 to the first node N1, and the first node N1 is at a low potential. The low potential of the first node N1 controls the second transistor M2 to be turned on, writing the high level of the second voltage signal VGH to the second node N2, and the second node N2 is at a high potential. The high potential of the second node N2 controls the fifth transistor M5 to be turned on, providing a low-level signal of the first voltage signal VGL to the output terminal of the control module 00. The control terminal of the first output module 10 receives a low-level signal, and the low-level signal controls the sixth transistor M6 to be turned on, providing the high level of the refresh control signal CTRL to the output terminal of the first output module 10. During this period, the output terminal of the first output module 10 outputs a high level of the first scan signal sn. Furthermore, the high-level signal of the second node N2 controls the eleventh transistors M11 in the second submodule 21 and the third submodule 22 to be turned off. The low level of the first clock signal CK1 controls the twelfth transistor M12 to be turned on, writing the low level of the second input signal IN-2 to the fifth node N5, and the fifth node N5 is at a low potential. The low-level signal at the fifth node N5 is written to the third node N3 and the fourth node N4 via each of the ninth transistors M9 in the submodule 21 and the submodule 22. The third node N3 and the fourth node N4 are at the low potential, controlling the tenth transistors M10 in the submodule 21 and the submodule 22 to be turned on. In the submodule 21, the high level of the second clock signal CK2 is provided to the output terminal of the submodule 21 via the tenth transistor M10, and the submodule 21 outputs a high-level signal of the first sub-scan signal sp1. In the submodule 22, the high level of the third clock signal CK3 is provided to the output terminal of submodule 22 via the tenth transistor M10, and submodule 22 outputs a high-level signal of the second sub-scan signal sp2.

During period t42, the first clock signal CK1 is at a high level, and the first transistor M1 is turned off. The first node N1 remains at a low potential, and the second node N2 remains at a high potential. The output terminal of the control module 00 is at a low potential, and the output terminal of the first output module 10 continues to output the high-level signal of the first scan signal sn. The twelfth transistor M12 is turned off, the third node N3 and the fourth node N4 remain at a low level, and the tenth transistor 10 in the submodule 21 is turned on, providing the low level of the second clock signal CK2 to the output terminal of the submodule 21. The submodule 21 outputs a low-level signal of the first sub-scan signal sp1. The tenth transistor 10 in the submodule 22 is turned on, and the third clock signal CK3 is a high-level signal. The submodule 22 outputs a high-level signal of the second sub-scan signal sp2.

During period t43, the first clock signal CK1 is at a high level, the first transistor M1 is turned off. The first node N1 remains at the low potential, and the second node N2 remains at the high potential. The output terminal of the control module 00 is at the low potential, and the output terminal of the first output module 10 continues to output the high-level signal of the first scan signal sn. The twelfth transistor M12 is turned off, the third node N3 remains at the low potential, and the fourth node N4 remains at the low potential. The tenth transistor 10 in the submodule 21 is turned on, the second clock signal CK2 is at a high level, and the submodule 21 outputs a high-level signal of the first sub-scan signal sp1. The tenth transistor 10 in the submodule 22 is turned on, the clock signal CK3 is a low-level signal, and the submodule 22 outputs a low-level signal of the second sub-scan signal sp2.

During period t44, the first clock signal CK1 is at a low level, controlling the first transistor M1 to be turned on. A high-level signal of the first input signal IN-1 is written to the first node N1, the first node N1 is at a high potential, the second node N2 is at a low potential, and the output terminal of the control module 00 is at a high potential. The sixth transistor M6 in the first output module 10 is turned off, and the seventh transistor M7 in the first output module 10 is turned on. The seventh transistor M7 provides a low-level signal of the first voltage signal VGL to the output terminal of the first output module 10, and the output terminal of the first output module 10 outputs a low-level signal of the first scan signal sn. During this period, the first clock signal CK1 controls the twelfth transistor M12 to be turned on, writing the high level of the second input signal IN-2 to the fifth node N5. The fifth node N5 is at a high potential, so that the third node N3 and the fourth node N4 are at a high potential. The tenth transistors M10 in the submodule 21 and the submodule 22 are turned off, and the eleventh transistors M11 in the submodule 21 and the submodule 22 are turned on under the control of the low potential of the second node N2. The submodule 21 outputs a high-level signal of the first sub-scan signal sp1, and the submodule 22 outputs a high-level signal of the second sub-scan signal sp2.

During the period t41 to t44, the first output module 10 completes the output of the first high-level pulse of the first scan signal sn, and the second output module 20 completes the output of the low-level pulse of the first sub-scan signal sp1 and the output of the low-level pulse of the second sub-scan signal sp2.

During period t45, the first clock signal CK1 is at a low level, controlling the first transistor M1 to be turned on and writing the low level of the first input signal IN-1 to the first node N1. The first node N1 is at a low potential, the second node N2 is at a high potential, and the output terminal of the control module 00 is at a low potential. The control terminal of the first output module 10 receives a low-level signal, controlling the sixth transistor M6 to be turned on and providing the high level of the refresh control signal CTRL to the output terminal of the first output module 10. The first output module 10 then outputs a high level of the first scan signal sn again. Furthermore, the high-level signal of the second node N2 controls the eleventh transistors M11 in the submodule 21 and the submodule 22 to be turned off. Furthermore, during this period, the second input signal IN-2 is a high-level signal, and the first clock signal CK1 is turned on, so that a high-level signal is written to the fifth node N5, thereby controlling the third node N3 and the fourth node N4 to be at a high potential. The tenth transistors M10 in the submodule 21 and the submodule 22 are turned off. The submodule 21 maintains outputting the high-level signal of the first sub-scan signal sp1, and the submodule 22 maintains outputting the high-level signal of the second sub-scan signal sp2.

During period t46, the first node N1 remains at a low potential, the second node N2 remains at a high potential, the fifth node N5 remains at a high potential, and the third node N3 and fourth node N4 remain at a high potential. The first output module outputs a high-level signal of the first scan signal sn, and the second output control module 20 outputs a high-level signal of the first sub-scan signal sp1 and a high-level signal of the second sub-scan signal sp2.

During period t47, the first clock signal CK1 is at a low level, controlling the first transistor M1 and the twelfth transistor M12 to be turned on. During this period, the first input signal IN-1 and the second input signal IN-2 are at a high potential. The first transistor M1 is turned on, a high-level signal is written to the first node N1, the second node N2 is at a low level, and the output terminal of the control module 00 connected to the first output module 10 outputs a high level. The first output module 10 outputs a low-level signal of the first scan signal sn. The twelfth transistor M12 is turned on to write a high level to the fifth node N5, and the third node N3 and the fourth node N4 are at a high potential. The eleventh transistor M11 in the second output module 20 is turned on under the control of the second node N2, the submodule 21 outputs a high level of the first sub-scan signal sp1, and the submodule 22 outputs a high-level signal of the second sub-scan signal sp2.

During the period t45 to t47, the first output module 10 completes outputting the second high-level pulse of the first scan signal sn, and the second output module 20 outputs a high-level signal of the first sub-scan signal sp1 and a high-level signal of the second sub-scan signal sp2.

When the shift register unit provided in the embodiment of FIG. 19 is driven using the signal timing provided in the embodiment of FIG. 27, the first scan signal sn includes two high-level pulse signals, and the second scan signal sp includes one low-level pulse signal. The embodiment of FIG. 19 enables the first scan signal sn to have multiple pulses. In this application, the first scan signal sn output by the shift register unit can provide the scan signal S2n shown in the timing diagram of FIG. 3.

It can be understood that in the shift register unit provided in the embodiment of FIG. 19, when the pulse signal of the first input signal IN-1 is a low-level pulse, the pulse signal of the second input signal IN-2 is a low-level pulse, and the refresh control signal CTRL is a high-level signal, the first scan signal sn output by the shift register unit comprises a high-level pulse signal, and the second scan signal sp comprises a low-level pulse signal. In other words, by configuring the input signal and the refresh control signal, the first scan signal sn output by the shift register unit provided in the embodiment of FIG. 19 can be a single pulse or multiple pulses.

The embodiment of FIG. 19 can realize a first scan signal sn having multiple pulses. The setting of the first input signal IN-1 does not need to consider compatibility with the output of the second output module 20 and can support more flexible waveform settings for the first scan signal sn, such as a first scan signal sn with multiple pulses or a first scan signal sn with a longer pulse width.

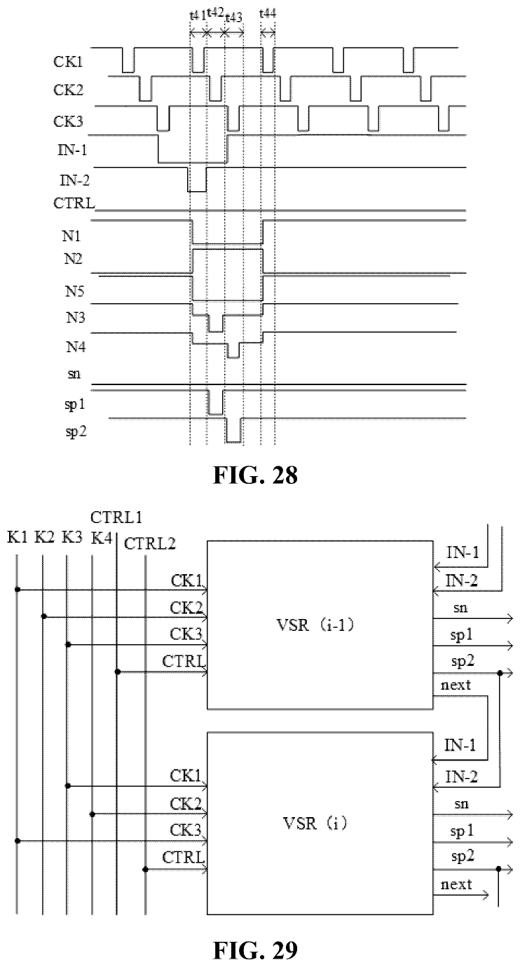

FIG. 28 is another operating timing diagram of a shift register unit provided by an embodiment of the present application. In the timing diagram of FIG. 28, the refresh control signal CTRL is a low-level signal, the pulse level of the first input signal IN-1 is a low level, and the pulse level of the second input signal IN-2 is a low level. When the shift register unit of FIG. 19 is driven using the signal timing provided by FIG. 28, the first output module 10 in the shift register unit outputs a low-level constant voltage signal, and the second output module 20 outputs the first sub-scan signal sp1 and the second sub-scan signal sp2.

The shift register unit provided in the embodiment of FIG. 19 operates in the first mode when being driven using the signal timing of FIG. 27, outputting the first scan signal sn and the second scan signal sp. The shift register unit provided in the embodiment of FIG. 19 operates in the second mode when being driven using the signal timing of FIG. 28, outputting a low-level constant voltage signal and the second scan signal sp.

In the embodiment of FIG. 19, the shift register unit receives a first input signal IN-1 and a second input signal IN-2. The control terminal of the first output module 10 is connected to the output terminal of the first inverter 1, and at least one control terminal of the second output module 20 is connected to the input terminal of the first inverter 1. At least one input terminal of the second output module 20 receives the second input signal IN-2 via the second input module 23. The shift register units are cascaded in the following manner.

FIG. 29 is a schematic diagram of another cascade of shift register units provided by an embodiment of the present application. FIG. 29 illustrates a cascade arrangement of the shift register units in FIG. 19. In conjunction with the timing diagrams of FIGS. 27 and 28, the pulse level of the first input signal IN-1 required for the shift register units to operate is a low level, the pulse level of the second input signal IN-2 is a low level, and the low-level start time of the second sub-scan signal sp2 in the second scan signal sp is later than the low-level start time of the first sub-scan signal sp1. FIG. 29 illustrates two cascaded shift register units VSR, namely, the shift register unit VSR(i−1) at the (i−1)^{th} stage and the shift register unit VSR(i) at the i^{th} stage. The input terminal of the first submodule 2 (referring to FIG. 19) in the shift register unit VSR(i) at the (i−1)^{th} stage is connected to the output terminal of the first inverter 1 (referring to FIG. 19) in the shift register unit VSR(i−1) at the (i−1)^{th} stage, where i is an integer, and i≥2. That is, the transfer-stage signal next output from the output terminal of the first inverter 1 in one stage of shift register unit serves as the first input signal IN-1 of the next-stage shift register unit. In addition, the input terminal (i.e., the input terminal of the second input module 23 in FIG. 19) of the second output module 20 in the shift register unit VSR(i) at the i^{th} stage receives the second sub-scan signal sp2 output by the shift register unit VSR(i−1) at the (i−1)^{th} stage. That is, when the shift register unit outputs two or more second scan signals sp, there is a phase difference between the different second scan signals sp. The second scan signal with the latest low-level start time is used as the second input signal IN-2 received by the next-stage shift register unit.

In the embodiment of FIG. 19, the first node N1 is connected to the first capacitor C1, and the first capacitor C1 is used to stabilize the potential of the first node N1. The signal at the output terminal of the first inverter 1 is used as the transfer-stage signal next. The first node N1 is not connected to the output terminal of the first inverter 1, which can reduce the risk of the first node N1 being interfered with by the next-stage shift register unit.

When driving the multiple cascaded shift register units shown in FIG. 29, the display panel requires four clock signal lines and two refresh control lines. The clock signal lines are the first clock signal line K1, the second clock signal line K2, the third clock signal line K3, and the fourth clock signal line K4. The clock signals provided by these four clock signal lines have the same period. The two refresh control lines are the first refresh control line CTRL1 and the second refresh control line CTRL2. The connection manner of the clock signal lines and refresh control lines with the shift register units is the same as that in the embodiment of FIG. 26 above, which is not repeated here.

The shift register composed of multiple shift register units in FIG. 29 can drive the display panel to perform partitioned refresh. Referring to the timing diagrams of FIGS. 27 and 28, the shift register units operate in the first mode when the refresh control signal CTRL is at the high level, and the shift register units operate in the second mode when the refresh control signal CTRL is at a low level. It can be understood that by controlling the first refresh control line CTRL1 and the second refresh control line CTRL2 to initially be high-level signals and then transitioning to low levels during a certain period, the multiple shift register units in the upper display region are driven in the first mode, and the multiple shift register units in the lower display region are driven in the second mode, which can realize that in one refresh frame of the display panel, the upper display region refreshes the image data, and the lower display region does not refresh the image.

In the embodiments of FIGS. 18 and 19, the first output module 10 includes two transistors. In the embodiments of the present application, the first output module 10 can also have other structures.

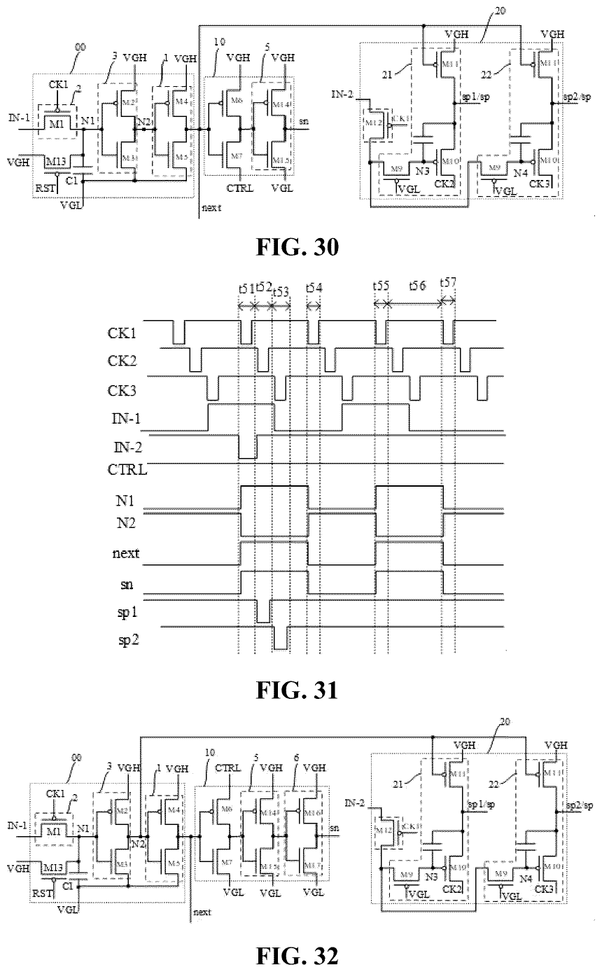

In other embodiments, FIG. 30 is another schematic diagram of a shift register unit provided by an embodiment of the present application. As shown in FIG. 30, the control module 00 includes a first inverter 1, a first submodule 2, and a second inverter 3. The first output module 10 includes a sixth transistor M6, a seventh transistor M7, and a fourth inverter 5. The sixth transistor M6 is a p-type transistor, and the seventh transistor M7 is an n-type transistor. The control terminals of the sixth transistor M6 and the seventh transistor M7 are connected to the output terminal of the first inverter 1. The first terminal of the sixth transistor M6 receives the second voltage signal VGH, and the first terminal of the seventh transistor M7 receives the refresh control signal CTRL. The second terminal of the sixth transistor M6 and the second terminal of the seventh transistor M7 are connected to the input terminal of the fourth inverter 5. The output terminal of the fourth inverter 5 serves as the output terminal of the first output module 10. The first port (e.g., the ground terminal) of the fourth inverter 5 receives the first voltage signal VGL, and the second port (e.g., the power supply terminal) receives the second voltage signal VGH. The fourth inverter 5 is a CMOS inverter and includes a fourteenth transistor M14 and a fifteenth transistor M15. The fourteenth transistor M14 is a p-type transistor, and the fifteenth transistor M15 is an n-type transistor. At least one control terminal of the second output module 20 is connected to the input terminal of the first inverter 1, and at least one input terminal of the second output module 20 receives the second input signal IN-2. The first level signal of the refresh control signal CTRL is a high-level signal, and the second level signal is a low-level signal. That is, when the refresh control signal CTRL is a high-level signal, the shift register unit operates in the first mode, and when the refresh control signal CTRL is a low-level signal, the shift register unit operates in the second mode.

In the first output module 10 provided in this embodiment, the refresh control signal CTRL is not directly connected to the fourth inverter 5. Consequently, the refresh control signal CTRL is not directly connected to the output transistors (transistors directly connected to the output terminals of the first output module 10) in the first output module 10. The refresh control signal CTRL serves as a control signal for the output transistors rather than an output signal, which can prevent fluctuations in the refresh control signal CTRL (such as transitions between high and low levels) from affecting the output signal of the first output module 10.

In addition, in the embodiment of FIG. 30, the fourteenth transistor M14 and the fifteenth transistor M15 serve as transistors directly connected to the output terminals of the first output module 10. The second voltage signal VGH received by the fourteenth transistor M14 can be provided by separate signal line, and the first voltage signal VGL received by the fifteenth transistor M15 can be provided by separate signal line. For example, the first terminal of the fifteenth transistor M15 and the first terminal of the fifth transistor M5 both receive the first voltage signal VGL, but these two transistors are connected to different signal lines. The first terminal of the fourteenth transistor M14 and the first terminal of the fourth transistor M4 both receive the second voltage signal VGH, but these two transistors are connected to different signal lines. This configuration can ensure the signal output performance of the first output module 10. Other related embodiments of the present application can refer to the description herein for individually configuring the constant voltage signal line connected to the output transistor in the first output module 10.

FIG. 31 is another operating timing diagram of a shift register unit provided by an embodiment of the present application. The timing diagram shown in FIG. 31 can be applied to the shift register unit shown in FIG. 30. In the timing diagram of FIG. 31, the refresh control signal CTRL is a high-level signal, the pulse level of the first input signal IN-1 is a high-level, and the pulse level of the second input signal IN-2 is a low-level. Combining FIGS. 30 and 31, the operating process of the shift register unit is as follows.

During period t51, the first clock signal CK1 controls the first transistor M1 to be turned on, writing the high level of the first input signal IN-1 to the first node N1; the first node N1 is at a high potential, the second node N2 is at a low potential, and the output terminal of the first inverter 1 is at a high potential. The control terminals of the sixth transistor M6 and the seventh transistor M7 in the first output module 10 receive high-level signals. These high-level signals control the seventh transistor M7 to be turned on, providing the low level of the refresh control signal CTRL to the input terminal of the fourth inverter 5, and the output terminal of the fourth inverter 5 outputs a high level, that is, the output terminal of the first output module 10 outputs a high-level signal of the first scan signal sn. Furthermore, the high-level signal at the output terminal of the first inverter 1 controls the eleventh transistors M11 in the submodule 21 and the submodule 22 to be turned off. The low level of the first clock signal CK1 controls the twelfth transistor M12 to be turned on, writing the low level of the second input signal IN-2 to the third node N3 of the submodule 21 and the fourth node N4 of submodule 22. The third node N3 and the fourth node N4 are at low potentials, controlling the turning on of the tenth transistors M10 in the submodule 21 and the submodule 22 each. During this period, the second clock signal CK2 and the third clock signal CK3 are both at a high level. The submodule 21 outputs a high-level signal of the first sub-scan signal sp1, and the submodule 22 outputs a high-level signal of the second sub-scan signal sp2.

During period t52, the first transistor M1 is turned off, the first node N1 is at a high potential, the second node N2 is at a low potential, and the output terminal of the first inverter 1 is at a high potential. The output terminal of the first output module 10 continues to output a high-level signal of the first scan signal sn. The third node N3 and the fourth node N4 remain at a low potential. The second clock signal CK2 is at a low-level signal, the submodule 21 outputs a low level of the first sub-scan signal sp1, the third clock signal CK3 is a high-level signal, and the submodule 22 outputs a high-level of the second sub-scan signal sp2.

During period t53, the first transistor M1 is turned off, the first node N1 is at a high potential, the second node N2 is at a low potential, and the output terminal of the first inverter 1 is at a high potential. The output terminal of the first output module 10 continues to output a high-level signal of the first scan signal sn. The third node N3 and the fourth node N4 remain at a low level. The second clock signal CK2 is a high-level signal, the submodule 21 outputs a high level of the first sub-scan signal sp1, the third clock signal CK3 is a low-level signal, and the submodule 22 outputs a low level of the second sub-scan signal sp2.

During period t54, the first clock signal CK1 is at a low level again, the first transistor M1 is turned on, writing the low level of the first input signal IN-1 to the first node N1, the second node N2 is at the high potential, and the output terminal of the first inverter 1 is at the low potential. The low potential at the output terminal of the first inverter 1 controls the sixth transistor M6 to be turned on, the input terminal of the fourth inverter 5 receives a high-level signal and outputs a low-level signal, so that the first output module 10 outputs a low level of the first scan signal sn. During this phase, the first clock signal CK1 controls the twelfth transistor M12 to be turned on, and the third node N3 and the fourth node N4 are written with the high potential, controlling the tenth transistor M10 in the submodule 21 and the submodule 22 to be turned off each. The low potential at the output terminal of the first inverter 1 controls the eleventh transistors M11 in the submodule 21 and the submodule 22 to be turned on, and the second output module 20 outputs the high level of the first sub-scan signal sp1 and the high level of the second sub-scan signal sp2.

During the period from t51 to t54, the first output module 10 completes the output of the first high-level pulse of the first scan signal sn, and the second output module 20 completes the output of the low-level pulse of the first sub-scan signal sp1 and the output of the low level pulse of the second sub-scan signal sp2.

During period t55, the first clock signal CK1 is at a low level, controlling the first transistor M1 to be turned on and writing the high level of the first input signal IN-1 to the first node N1. The first node N1 is at a high potential, the second node N2 is at a low potential, and the output terminal of the first inverter 1 is at a high potential. The first output module 10 in the period t55 operates in the same manner as the first output module 10 in the period t51, outputting a high level of the first scan signal sn. In the second output module 20, since the second input signal IN-2 is a high-level signal, the third node N3 and the fourth node N4 are at a high potential, turning off the tenth transistor M10 and the eleventh transistor M11. The second output module 20 outputs a high level of the first sub-scan signal sp1 and a high level of the second sub-scan signal sp2.

During period t56, the first output module outputs a high-level signal of the first scan signal sn, and the second output control module 20 outputs a high-level signal of the first sub-scan signal sp1 and a high-level signal of the second sub-scan signal sp2.

During period t57, the first clock signal CK1 is at a low level, controlling the first transistor M1 and the twelfth transistor M12 to be turned on. During this period, the first input signal IN-1 is at a low level, and the second input signal IN-2 is at a high level. The first transistor M1 is turned on, a low level is written to the first node N1, the second node N2 is at a high level, and the output terminal of the first inverter 1 is at a low level. The first output module 10 outputs a low-level signal of the first scan signal sn. The twelfth transistor M12 is turned on, writing a high level to the fifth node N5, and the third node N3 and the fourth node N4 are at a high potential. The eleventh transistor M11 in the second output module 20 is turned on under the control of the low level at the output terminal of the first inverter 1, and the second output module 20 outputs a high-level signal of the first sub-scan signal sp1 and a high-level signal of the second sub-scan signal sp2.

During the period t55 to t57, the first output module 10 completes the output of the second high-level pulse of the first scan signal sn, and the second output module 20 outputs a high-level signal of the first sub-scan signal sp1 and a high-level signal of the second sub-scan signal sp2.

When the shift register unit provided in the embodiment of FIG. 30 is driven using the signal timing provided in the embodiment of FIG. 31, the first scan signal sn includes two high-level pulse signals, and the second scan signal sp includes one low-level pulse signal. The embodiment of FIG. 30 enables the first scan signal sn to have multiple pulses. In applications, the first scan signal sn output by the shift register unit can provide the scan signal S2n shown in the timing diagram of FIG. 3.

The embodiment of FIG. 30 can realize a first scan signal sn having multiple pulses. The setting of the first input signal IN-1 does not need to consider compatibility with the output of the second output module 20 and can support more flexible waveform settings of the first scan signal sn, such as a first scan signal sn with multiple pulses or a first scan signal sn with a longer pulse width.

FIG. 31 illustrates the timing when the refresh control signal CTRL is at a high level. The first output module 10 of the shift register unit outputs a first scan signal sn comprising two high-level pulses, and the second output module 20 outputs a first sub-scan signal sp1 and a second sub-scan signal sp2 that each comprise a low-level pulse. It can be understood that when the refresh control signal CTRL is at a low level, the first output module 10 of the shift register unit outputs a first scan signal sn as a low-level constant voltage signal, and the second output module 20 outputs a first sub-scan signal sp1 and a second sub-scan signal sp2 that each comprise a low-level pulse. In other words, when the refresh control signal CTRL is at a high level, the shift register unit operates in the first mode, and when the refresh control signal CTRL is at a low level, the shift register unit operates in the second mode.

In addition, in the embodiment of FIG. 30, the signal at the output terminal of the first inverter 1 can serve as the transfer-stage signal next, providing the first input signal IN-1 required by the next-stage shift register unit. The shift register units provided in the embodiment of FIG. 30 can be cascaded using the cascade arrangement illustrated in FIG. 29 above, which is not further described here.

In other embodiments, FIG. 32 is another schematic diagram of a shift register unit provided by an embodiment of the present application. The structures of the control module 00 and the second control module 20 in FIG. 32 are the same as those in the embodiment of FIG. 30 and are not repeated here. As shown in FIG. 32, the first output module 10 includes a sixth transistor M6, a seventh transistor M7, a fourth inverter 5, and a fifth inverter 6. The sixth transistor M6 is a p-type transistor, and the seventh transistor M7 is an n-type transistor. The control terminal of the sixth transistor M6 and the control terminal of the seventh transistor M7 each are connected to the output terminal of the first inverter 1. The first terminal of the sixth transistor M6 receives the refresh control signal CTRL, and the first terminal of the seventh transistor M7 receives the first voltage signal VGL. The second terminal of the sixth transistor M6 and the second terminal of the seventh transistor M7 each are connected to the input terminal of the fourth inverter 5. The output terminal of the fourth inverter 5 is connected to the input terminal of the fifth inverter 6. The output terminal of the fifth inverter 6 serves as the output terminal of the first output module 10. The first port of the fourth inverter 5 and the first port of the fifth inverter 6 receive the first voltage signal VGL, and the second port of the fourth inverter 5 and the second port of the fifth inverter 6 receive the second voltage signal VGH. The first port of the inverter serves as the ground terminal and the second port serves as the power supply terminal. The fourth inverter 5 and the fifth inverter 6 are CMOS inverters. The fourth inverter 5 includes a fourteenth transistor M14 and a fifteenth transistor M15, and the fifth inverter 6 includes a sixteenth transistor M16 and a seventeenth transistor M17. The first level signal of the refresh control signal CTRL is a low-level signal, and the second level signal is a high-level signal.

In the first output module 10 provided in this embodiment, the refresh control signal CTRL is not directly connected to the fifth inverter 6, that is, the refresh control signal CTRL is not directly connected to the output transistors in the first output module 10. The refresh control signal CTRL serves as a control signal for the output transistors rather than an output signal, which prevents fluctuations in the refresh control signal CTRL (such as transitions between high and low levels) from affecting the output signal of the first output module 10.

By replacing the refresh control signal CTRL in FIG. 27 with a low-level signal, the shift register unit provided in the embodiment of FIG. 32 can be driven using the signal timing provided in the embodiment of FIG. 27. During this signal timing, the refresh control signal CTRL is a low-level signal, the pulse level of the first input signal IN-1 is a low level, and the pulse level of the second input signal IN-2 is a low level. The shift register unit can output a first scan signal sn and two second scan signals sp (that is, a first sub-scan signal sp1 and a second sub-scan signal sp2). The first scan signal sn includes two high-level pulses, and the first sub-scan signal sp1 and the second sub-scan signal sp2 each include a low-level pulse. During this signal timing, the refresh control signal CTRL is a high-level signal, the pulse level of the first input signal IN-1 is a low level, and the pulse level of the second input signal IN-2 is a low level. The shift register unit can output a low-level constant voltage signal and the two second scan signals sp.

In addition, in the embodiment of FIG. 32, the signal at the output terminal of the first inverter 1 can serve as the transfer-stage signal next, providing the first input signal IN-1 required by the next-stage shift register unit. The shift register units provided in the embodiment of FIG. 32 can be cascaded using the cascade arrangement illustrated in FIG. 29 above, which is not described in detail here.

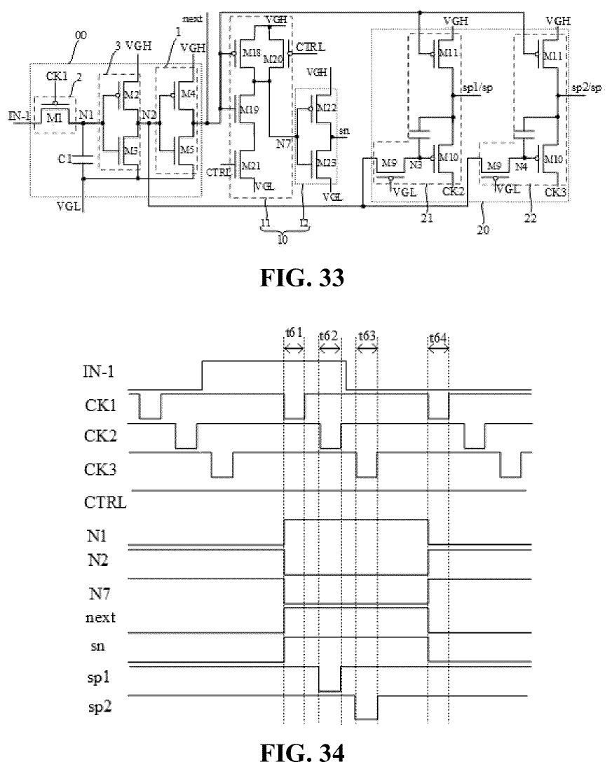

In other embodiments, FIG. 33 is another schematic diagram of a shift register unit provided by an embodiment of the present application. As shown in FIG. 33, the control module 00 includes a first inverter 1, a first submodule 2, and a second inverter 3. The first submodule 2 receives the first input signal IN-1. The output terminal of the first submodule 2 and the input terminal of the second inverter 3 are connected to the first node N1. The output terminal of the second inverter 3 and the input terminal of the first inverter 1 are connected to the second node N2. The first output module 10 includes a NAND gate 11 and a sub-output module 12. The first input terminal of the NAND gate 11 is connected to the output terminal of the first inverter 1, and the second input terminal of the NAND gate 11 receives the refresh control signal CTRL. The output terminal of the NAND gate 11 and the sub-output module 12 are connected to a seventh node N7. The NAND gate 11 is configured to output a first control signal when the refresh control signal CTRL is a first level signal, and to output a second control signal when the refresh control signal CTRL is a second level signal. The sub-output module 12 is configured to output a first scan signal sn based on the first control signal output by the NAND gate 11, a first voltage signal VGL, and a second voltage signal VGH, and to output a low-level constant voltage signal based on the second control signal output by the NAND gate 11, the first voltage signal VGL, and the second voltage signal VGH. Optionally, the first level signal of the refresh control signal CTRL is a high-level signal, and the second level signal is a low-level signal. In this embodiment, the signal at the output terminal of the first inverter 1 serves as the transfer-stage signal next, that is, as the first input signal IN-1 required for the next-stage shift register unit in a cascade connection.

In addition, FIG. 33 shows that the second output module 20 includes two submodules, which are a submodule 21 and a submodule 22. The submodule 21 is configured to output the first sub-scan signal sp1, and the submodule 22 is configured to output the second sub-scan signal sp2. One control terminal of the submodule 21 and one control terminal of the submodule 22 are connected to the output terminal of the first inverter 1, and one input terminal of the submodule 21 and one input terminal of the submodule 22 are connected to the input terminal of the first inverter 1.

Specifically, as shown in FIG. 33, the NAND gate 11 includes an eighteenth transistor M18, a nineteenth transistor M19, a twentieth transistor M20, and a twenty-first transistor M21. The eighteenth transistor M18 and the twentieth transistor M20 are p-type transistors and the nineteenth transistor M19 and the twenty-first transistors M21 are n-type transistors. The control terminals of the eighteenth transistor M18 and the nineteenth transistor M19 are connected to the output terminal of the first inverter 1. The control terminals of the twentieth transistor M20 and the twenty-first transistor M21 receive the refresh control signal CTRL. The first terminal of the eighteenth transistor M18 and the first terminal of the twentieth transistor M20 receive the second voltage signal VGH, and the second terminal of the eighteenth transistor M18 and the second terminal of the twentieth transistor M20 are connected to the output terminal of the NAND gate 11. The first terminal of the twenty-first transistor M21 receives the first voltage signal VGL, and the second terminal of the twenty-first transistor M21 is connected to the first terminal of the nineteenth transistor M19, and the second terminal of the nineteenth transistor M19 is connected to the output terminal of the NAND gate 11. The sub-output module 12 includes a twenty-second transistor M22 and a twenty-third transistor M23. The control terminal of the twenty-second transistor M22 and the control terminal of the twenty-third transistor M23 are connected to the output terminal of the NAND gate 11. The first terminal of the twenty-second transistor M22 receives the second voltage signal VGH, the first terminal of the twenty-third transistor M23 receives the first voltage signal VGL, and the second terminal of the twenty-second transistor M22 and the second terminal of the twenty-third transistor M23 are connected to the output terminal of the first output module 10. The twenty-second transistor M22 is a p-type transistor and the twenty-third transistor M23 is an n-type transistor.

FIG. 34 is another operating timing diagram of a shift register unit provided by an embodiment of the present application. The signal timing in FIG. 34 can be used to drive the shift register unit provided in the embodiment of FIG. 33. FIG. 34 illustrates the refresh control signal CTRL at a high level and the pulse level of the first input signal IN-1 at a high level. The shift register unit operates as follows.

During period t61, the first clock signal CK1 controls the first transistor M1 to be turned on. The high level of the first input signal IN-1 is written to the first node N1. The input terminal of the second inverter 3 receives a high level, the output terminal of the second inverter 3 outputs a low level, the second node N2 is at a low potential, the input terminal of the first inverter 1 is connected to the second node N2, and the output terminal of the first inverter 1 outputs a high-level signal. For the NAND gate 11, a high-level signal is input to the first input terminal of the NAND gate 11 and a high-level signal (provided by the refresh control signal CTRL) is input to the second input terminal of the NAND gate 11, the output terminal of the NAND gate 11 outputs a low level, and the seventh node N7 is at a low potential. The low potential of the seventh node N7 controls the twenty-second transistor M22 in the sub-output module 12 to be turned on, and the first output module 10 outputs a high-level signal of the first scan signal sn. In addition, the second node N2 is at a low potential, a low-level signal is written to the third node N3 of the submodule 21, and a low-level signal is written to the fourth node N4 of submodule 22. The submodule 21 outputs a high level of the first sub-scan signal sp1, and the submodule 22 outputs a high level of the second sub-scan signal sp2.

During period t62, the first node N1 remains at a high potential, the second node N2 remains at a low potential, the output terminal of the first inverter 1 outputs a high-level signal, and the first output module 10 outputs a high-level signal of the first scan signal sn. The third node N3 remains at a low potential, the second clock signal CK2 is at a low level, and the submodule 21 outputs a low level of the first sub-scan signal sp1. The fourth node N4 remains at a low potential, the third clock signal CK3 is at a high level, and the submodule 22 outputs a high level of the second sub-scan signal sp2.

During period t63, the first node N1 remains at a high potential, the second node N2 remains at a low potential, the output terminal of the first inverter 1 outputs a high-level signal, and the first output module 10 outputs a high-level signal of the first scan signal sn. The third node N3 remains at a low potential, the second clock signal CK2 is at a high level, and the submodule 21 outputs a high level of the first sub-scan signal sp1. The fourth node N4 remains at a low potential, the third clock signal CK3 is at a low level, and the submodule 22 outputs a low level of the second sub-scan signal sp2.

During period t64, the first clock signal CK1 controls the first transistor M1 to be turned on, the low level of the first input signal IN-1 is written to the first node N1, the second node N2 is at a high potential, and the output terminal of the first inverter 1 outputs a low-level signal. For the NAND gate 11, a low-level signal is input to its first input terminal and a high-level signal (provided by the refresh control signal CTRL) is input to its second input terminal, the its output terminal outputs a high level, and the seventh node N7 is at a high potential. The high potential of the seventh node N7 controls the twenty-third transistor M23 in the sub-output module 12 to be turned on, so that the first output module 10 outputs a low-level signal of the first scan signal sn. In addition, the low-level signal at the output terminal of the first inverter 1 controls the eleventh transistors M11 in the submodule 21 and the submodule 22 to be turned on, so that the submodule 21 outputs a high level of the first sub-scan signal sp1, and the submodule 22 outputs a high level of the second sub-scan signal sp2.

During the period from t61 to t64, the first output module 10 completes the output of the high-level pulse of the first scan signal, the second output module 20 completes the output of the low-level pulse of the first sub-scan signal sp1, and the output of the low-level pulse of the second sub-scan signal sp2, and the shift register unit operates in the first mode.

When the refresh control signal CTRL is at a low level, during the period from t61 to t64 in the timing of FIG. 34, the first output module 10 outputs a low-level constant voltage signal, the second output module 20 outputs the first sub-scan signal sp1 and the second sub-scan signal sp2, and the shift register unit operates in the second mode. That is, the shift register unit provided in the embodiment of FIG. 33 operates in a first mode when the refresh control signal CTRL is a high-level signal, and operates in a second mode when the refresh control signal CTRL is a low-level signal.

In some embodiments, the display panel includes a first signal line, and the first signal line is configured to provide the refresh control signal CTRL. The second input terminal of the NAND gate 11 is connected to the first signal line. That is, in the embodiment of FIG. 33, the control terminal of the twentieth transistor M20 and the control terminal of the twenty-first transistor M21 are directly connected to the first signal line. In this embodiment, two refresh control lines are required when the shift register units are cascaded. The two refresh control lines are alternately connected to the cascaded shift register units to avoid abnormal signal output at some positions caused by voltage transitions on the refresh control lines during a partitioned refresh display.

In the embodiment of FIG. 33, the control module 00 includes a first submodule 2, a second inverter 3, and a first inverter 1. The first submodule 2 receives a first input signal IN-1. The output terminal of the first submodule 2 and the input terminal of the second inverter 3 are connected to a first node N1. The output terminal of the second inverter 3 and the input terminal of the first inverter 1 are connected to a second node N2. A first output module 10 is connected to the output terminal of the first inverter 1, and a second output module 20 is connected to the output terminal and the input terminal of the first inverter 1. In applications, the shift register units can be cascaded in the following manner.

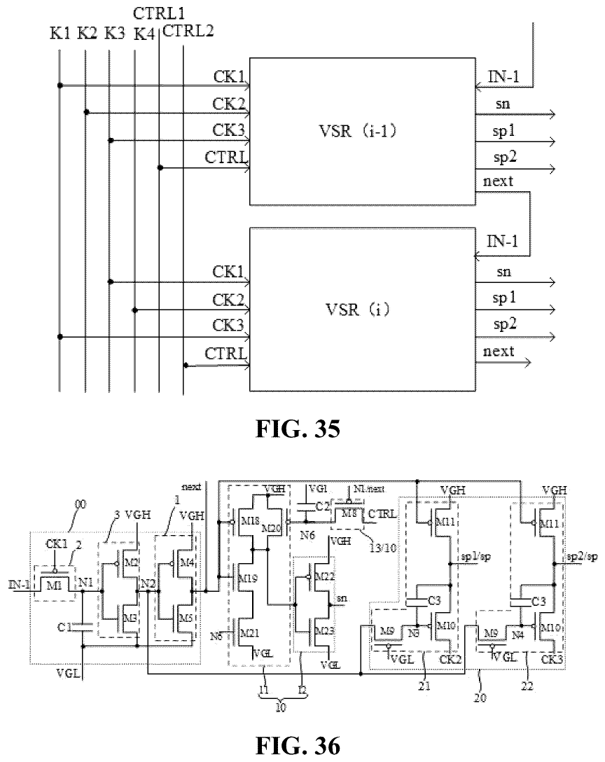

FIG. 35 is a schematic diagram of another cascade of shift register units provided by yet another embodiment of the present application. FIG. 35 illustrates a cascade arrangement of the shift register units in FIG. 33. Referring to FIG. 33 and FIG. 34, the pulse level of the first input signal IN-1 required for the shift register units to operate is a high level. The input terminal of the first submodule 2 receives the first input signal IN-1, and the signal at the output terminal of the first inverter 1 serves as the transfer-stage signal next. FIG. 35 illustrates two cascaded shift register units VSR, namely, the shift register unit VSR(i−1) at the (i−1)^{th} stage and the shift register unit VSR(i) at the i^{th} stage. The input terminal of the first submodule 2 (referring to FIG. 33) in the shift register unit VSR(i) at the i^{th} stage is connected to the output terminal of the first inverter 1 in the shift register unit VSR(i−1) at the (i−1)^{th} stage. That is, the first input signal IN-1 received by the current-stage shift register unit is the transfer-stage signal next output by the output terminal of the first inverter 1 in the previous-stage shift register unit.

When driving the multiple cascaded shift register units shown in FIG. 35, the display panel requires four clock signal lines and two refresh control lines. The clock signal lines are the first clock signal line K1, the second clock signal line K2, the third clock signal line K3, and the fourth clock signal line K4. The clock signals provided by the four clock signal lines have the same period. The two refresh control lines are the first refresh control line CTRL1 and the second refresh control line CTRL2, which are alternately connected to the cascaded shift register units. The connection manner between the shift register units and the clock signal lines is the same as that in the embodiment of FIG. 26 above, which is not further described here.

In other embodiments, FIG. 36 is another schematic diagram of a shift register unit provided by an embodiment of the present application. The structures of the control module 00 and the second output module 20 in FIG. 36 are the same as those in the embodiment of FIG. 33, and the distinction of the two lies in the first output module 10 having different structures. As shown in FIG. 36, the first output module 10 includes an input unit 13. The input terminal of input unit 13 receives the refresh control signal CTRL, and the output terminal of input unit 13 is connected to the second input terminal of the NAND gate 11. The input unit 13 is configured to write the refresh control signal CTRL into the second input terminal of the NAND gate 11 when the input unit 13 is turned on. As shown in FIG. 36, the second input terminal of the NAND gate 11 and the input unit 13 are connected to the sixth node N6.

In the embodiment of FIG. 36, the signal timing provided in FIG. 34 can be used for driving. When the refresh control signal CTRL is high-level signal, the shift register unit operates in the first mode, outputting the first scan signal sn and two second scan signals sp (including the first sub-scan signal sp1 and the second sub-scan signal sp2). When the refresh control signal CTRL is a low-level signal, the shift register unit operates in the second mode, outputting a low-level constant voltage signal and the two second scan signals sp.

In the cascade connection, the signal at the output terminal of the first inverter 1 in the embodiment of FIG. 36 can serve as the transfer-stage signal next. That is, the input terminal of the first submodule 2 in the shift register unit VSR(i) at the i^{th} stage is connected to the output terminal of the first inverter 1 in the shift register unit VSR(i−1) at the (i−1)^{th} stage. In other words, the first input signal IN-1 received by the current-stage shift register unit serves as the transfer-stage signal next output by the output terminal of the first inverter 1 in the previous-stage shift register unit.

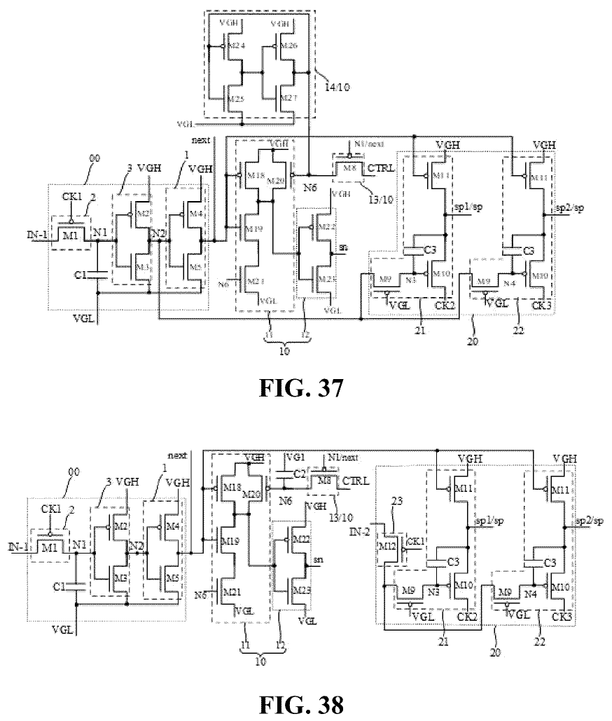

When driving multiple cascaded shift register units in the embodiment of FIG. 37, the display panel requires four clock signal lines and one refresh control line.

In one embodiment, as shown in FIG. 36, the input unit 13 includes an eighth transistor M8, which is a p-type transistor. The control terminal of the eighth transistor M8 is connected to the output terminal of the first inverter 1. The output terminal of the first inverter 1 outputs the transfer-stage signal next. That is, the control terminal of the eighth transistor M8 receives the transfer-stage signal next output by the output terminal of the first inverter 1 in the current-stage shift register unit. Alternatively, the control terminal of the eighth transistor M8 is connected to the output terminal of the first submodule 2, that is, the first submodule 2 is connected to the first node N1.

In another embodiment, the input unit 13 includes an eighth transistor M8, which is an n-type transistor; the control terminal of the eighth transistor M8 is connected to the input terminal of the first inverter 1, which is not illustrated here. In this embodiment, when the refresh control signal CTRL is a low-level signal, the low level written to the second input terminal of the NAND gate 11 can be closer to the voltage value provided by the refresh control signal CTRL, thereby more accurately controlling the transistors in the latch 14.

As shown in FIG. 36, the first output module 10 includes a second capacitor C2. The first plate of the second capacitor C2 is connected to the second input terminal of the NAND gate 11, and the second plate of the second capacitor C2 is connected to the constant voltage signal terminal VG1. The constant voltage signal terminal VG1 can output either the first voltage signal VGL or the second voltage signal VGH. The second capacitor C2 can stabilize the potential of the sixth node N6, so that the signal at the second input terminal of the NAND gate 11 is more stable, thereby ensuring the stability of the output signal of the first output module 10.

In another embodiment, FIG. 37 is another schematic diagram of a shift register unit provided by an embodiment of the present application. The structures of the control module 00 and the second output module 20 in FIG. 37 are the same as those in the embodiment of FIG. 33, but the distinction lies in the first output module 10 having different structures. As shown in FIG. 37, the first output module 10 includes a latch 14, an input terminal and an output terminal of the latch 14 are connected to the second input terminal of the NAND gate 11. That is, the latch 14 and the second input terminal of the NAND gate 11 are connected to the sixth node N6. The latch 14 includes a twenty-fourth transistor M24, a twenty-fifth transistor M25, a twenty-sixth transistor M26, and a twenty-seventh transistor M27. The twenty-fourth transistor M24 and the twenty-fifth transistor M25 form an inverter, while the twenty-sixth transistor M26 and the twenty-seventh transistor M27 form another inverter. The twenty-fourth transistor M24 and the twenty-sixth transistor M26 are p-type transistors, and the twenty-fifth transistor M25 and the twenty-seventh transistor M27 are n-type transistors. In this embodiment, the latch 14 can make the voltage at the second input terminal of the NAND gate 11 more stable. When the refresh control signal CTRL is a low-level signal, the low level written to the second input terminal of the NAND gate 11 can be closer to the voltage value provided by the refresh control signal CTRL, thereby more accurately controlling the transistors in the NAND gate 11.

In the embodiment of FIG. 37, the signal timing provided in FIG. 34 can be used for driving. When the refresh control signal CTRL is a high-level signal, the shift register unit operates in the first mode, outputting the first scan signal sn, the first sub-scan signal sp1, and the second sub-scan signal sp2. When the refresh control signal CTRL is a low-level signal, the shift register unit operates in the second mode, outputting a low-level constant voltage signal, the first sub-scan signal sp1, and the second sub-scan signal sp2.

In the cascade connection, the signal at the output terminal of the first inverter 1 in the embodiment of FIG. 37 can serve as the transfer-stage signal next. That is, the input terminal of the first submodule 2 in the shift register unit VSR(i) at the i^{th} stage is connected to the output terminal of the first inverter 1 in the shift register unit VSR(i−1) at the (i−1)^{th} stage. In other words, the first input signal IN-1 received by the current-stage shift register unit serves as the transfer-stage signal next output by the output terminal of the first inverter 1 in the previous-stage shift register unit.

When driving multiple cascaded shift register units in the embodiment of FIG. 37, the display panel requires four clock signal lines and one refresh control line.

In the embodiments of FIGS. 33 to 37 above, the structures of the control modules 00 are the same, the structures of the second output modules 20 are the same, and the connection manner between the second output module 20 and the control module 00 is the same as that in the embodiment of FIG. 20 above. The difference between the embodiments of FIGS. 33 to 37 lies in the first output module 10 having different structures. The structures of the first output modules 10 in the embodiments of FIGS. 33 to 37 above can also be applied to the embodiment of FIG. 21. Taking the first output module 10 in FIG. 36 applied to the embodiment of FIG. 21 as an example.

FIG. 38 is another schematic diagram of a shift register unit provided by an embodiment of the present application. As shown in FIG. 38, the control module 00 includes a first inverter 1, a first submodule 2, and a second inverter 3. The first output module 10 includes a NAND gate 11, a sub-output module 12, and an input unit 13. The first input terminal of the NAND gate 11 is connected to the output terminal of the first inverter 1, and the output terminal of the input unit 13 is connected to the second input terminal of the NAND gate 11. The input unit 13 is configured to write the refresh control signal CTRL to the second input terminal of NAND gate 11 when the input unit 13 is turned on. The output terminal of NAND gate 11 is connected to the sub-output module 12; the NAND gate 11 is configured to output a first control signal when the refresh control signal CTRL is a first level signal, and to output a second control signal when the refresh control signal CTRL is a second level signal. The sub-output module 12 is configured to output a first scan signal sn based on the first control signal output by the NAND gate 11, the first voltage signal VGL, and the second voltage signal VGH, and to output a low-level constant voltage signal based on the second control signal output by the NAND gate 11, the first voltage signal VGL, and the second voltage signal VGH. The second output module 20 includes a submodule 21 and a submodule 22. The submodule 21 is configured to output the second scan signal sp1 and the submodule 22 is configured to output the third scan signal sp2. One control terminal of the submodule 21 and one control terminal of the submodule 22 are connected to the output terminal of the first inverter 1. One input terminal of the submodule 21 and one input terminal of the submodule 22 each receive the second input signal IN-2 through a second input module 23.

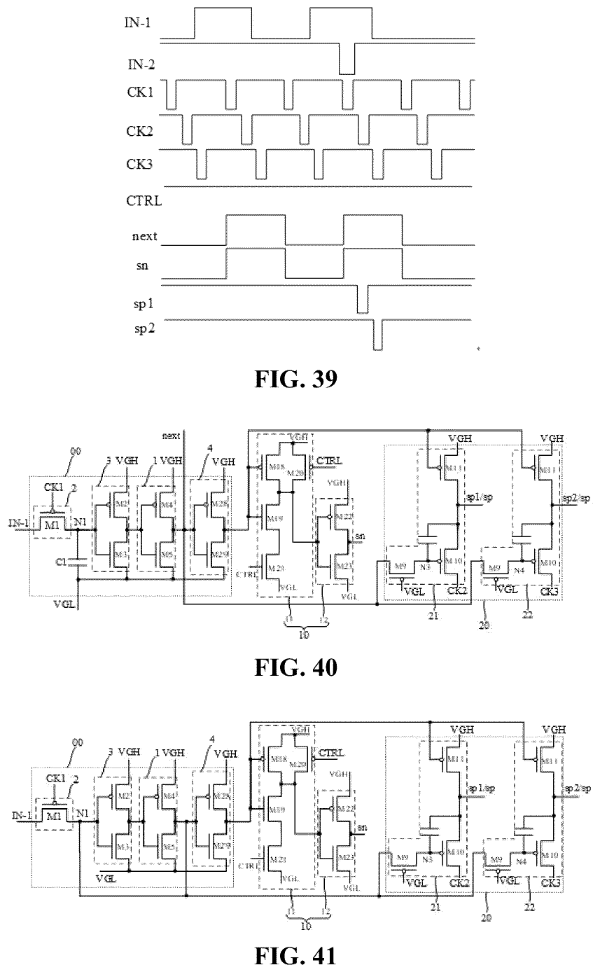

FIG. 39 is another timing diagram of a shift register unit provided by an embodiment of the present application. The signal timing shown in FIG. 39 can be used to drive the shift register unit provided in the embodiment of FIG. 38. The pulse level of the first input signal IN-1 is a high level and the pulse level of the second input signal IN-2 is a low level. When the refresh control signal CTRL is a high-level signal, the shift register unit operates in the first mode, outputting the first scan signal sn, the first sub-scan signal sp1, and the second sub-scan signal sp2. When the first input signal IN-1 includes two high-level pulses, the first scan signal sn includes two high-level pulses. When the refresh control signal CTRL is a low-level signal, the shift register unit operates in the second mode, outputting a low-level constant voltage signal, the first sub-scan signal sp1, and the second sub-scan signal sp2. This embodiment can realize a first scan signal sn having multiple pulses. The setting of the first input signal IN-1 does not need to consider compatibility with the output of the second output module 20, and can support more flexible waveform settings for the first scan signal sn, such as a first scan signal sn with multiple pulses or a first scan signal sn with a longer pulse width.

In the cascade connection, in the embodiment of FIG. 38, the input terminal of the first submodule 2 in the shift register unit VSR(i) at the i^{th} stage is connected to the output terminal of the first inverter 1 in the shift register unit VSR(i−1) at the (i−1)^{th} stage. This is, the first input signal IN-1 received by the current-stage shift register unit is the transfer stage signal next output by the output terminal of the first inverter 1 in the previous-stage shift register unit. Furthermore, the low-level start time of the second sub-scan signal sp2 is later than the low-level start time of the first sub-scan signal sp1. The input terminal (i.e., the input terminal of the second input module 23 in FIG. 38) of the second output module 20 in the shift register unit VSR(i) at the i^{th} stage receives the second sub-scan signal sp2 output by the shift register unit VSR(i−1) at the (i−1)^{th} stage. The second sub-scan signal sp2 is the one with the latest low-level start time among the two second scan signals output by the second output module 20.

When driving multiple cascaded shift register units in the embodiment of FIG. 38, the display panel requires four clock signal lines and one refresh control line.

The structure of the first output module 10 in the embodiments of FIGS. 33 to 37 can also be applied to the embodiment of FIG. 22. Take the first output module 10 in FIG. 33 applied to the embodiment of FIG. 22 as an example. FIG. 40 is another schematic diagram of a shift register unit provided by an embodiment of the present application. As shown in FIG. 40, the control module 00 includes a first inverter 1, a second inverter 3, a third inverter 4, and a first submodule 2. The input terminal of the first submodule 2 receives the first input signal IN-1, and the output terminal of the first submodule 2 and the input terminal of the second inverter 3 are connected to the first node N1. The output terminal of the second inverter 3 is connected to the input terminal of the first inverter 1, and the input terminal of the third inverter 4 is connected to the output terminal of the first inverter 1. Specifically, the third inverter 4 includes a twenty-eighth transistor M28 and a twenty-ninth transistor M29. The twenty-eighth transistor M28 is a p-type transistor and the twenty-ninth transistor M29 is an n-type transistor. At least one control terminal of the first output module 10 is connected to the output terminal of the third inverter 4. That is, At least one control terminal of the first output module 10 is connected to the output terminal of the first inverter 1 through the third inverter 4. At least one control terminal of the second output module 20 is connected to the output terminal of the third inverter 4 and at least one input terminal of the second output module 20 is connected to the output terminal of the first inverter 1. The structure of the first output module 10 is the same as that shown in FIG. 34 above, which is not described in detail here. In this embodiment, a third inverter 4 is added to the output terminal of the first inverter 1 of the control module 00. Compared with FIG. 33, when driving the shift register unit, the pulse level of the first input signal IN-1 needs to be inverted. In the embodiment of FIG. 40, the pulse level of the first input signal IN-1 required for the shift register unit to operate is a low level, so that the first node N1 connecting the first submodule 2 and the second inverter 3 is at a low level for most of the time, which can mitigate the impact on power consumption caused by the third transistor M3 in the second inverter 3 failing to be turned off when the first node N1 is at a high level for most of the time, which would otherwise lead to a short circuit between the high and low voltage receiving terminals. In this embodiment, the signal at the output terminal of the first inverter 1 can serve as the transfer-stage signal next. In a cascade connection, the output terminal of the first inverter 1 is connected to the input terminal of the first submodule 2 in the next-stage shift register unit.

The structure of the first output module 10 in the embodiments of FIGS. 33 to 37 can also be applied to the embodiment of FIG. 23. Take the first output module 10 in FIG. 33 applied to the embodiment of FIG. 23 as an example. FIG. 41 is another schematic diagram of a shift register unit provided by an embodiment of the present application. The difference between the embodiment of FIG. 41 and the embodiment of FIG. 40 is that the output terminal of the first inverter 1 is connected to the first node N1, so that the first inverter 1 and the second inverter 2 are connected end-to-end to form a latch structure, which allows the first capacitor C1 in FIG. 40 to be omitted, and the low-potential voltage of the first node N1 can reach the voltage value provided by the first voltage signal VGL. Furthermore, to avoid the impact of the latch structure on the cascade connection, the signal at the output terminal of the first inverter 1 is no longer used as the transfer-stage signal in the embodiment. Instead, the pulse level of the first input signal IN-1 is changed to a low level. When the shift register units are cascaded, one second scan signal output by the previous-stage second output module 20 is used as the transfer-stage signal.

In the above embodiments, the second output module 20 includes two submodules (the submodule 21 and the submodule 22). Therefore, the second output module 20 outputs two second scan signals sp. It can be understood that by setting the number of the submodules in the second output module 20, the number of second scan signals sp output by the shift register unit can be adjusted. In a case where the second output module 20 includes one submodule, the second output module 20 can output one second scan signal sp. In a case where the second output module 20 includes three submodules, the second output module 20 can output three second scan signals sp through the clock signals, and there can be phase differences between the three second scan signals sp, which is not illustrated in the drawings here.

In some embodiments of the present application, the first scan signal sn output by the shift register unit includes a high-level pulse, as shown in the embodiment of FIG. 18. In this embodiment, the first scan signal sn output by the shift register unit can be used as the scan signal Sin or S2n required in the timing of FIG. 2.

In other embodiments, the first scan signal sn output by the shift register unit can include a high-level pulse or two high-level pulses, as shown in the embodiment of FIG. 19. When the first scan signal sn includes two high-level pulses, the first scan signal sn can be used as the scan signal S2n required in the timing of FIG. 3. When the first scan signal sn includes a high-level pulse, the first scan signal sn can be used as the scan signal Sin or S2n required in the timing of FIG. 2.

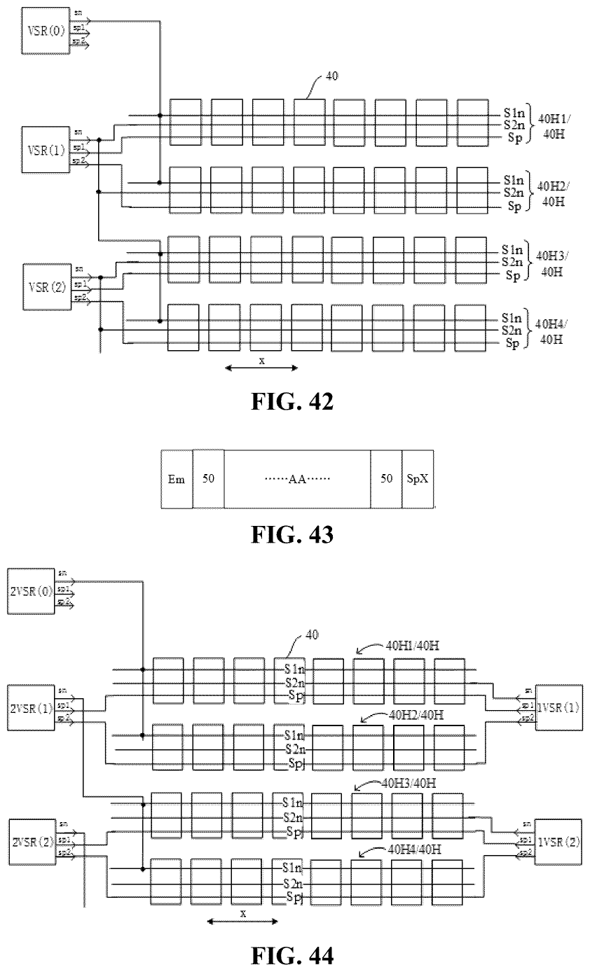

In some embodiments, FIG. 42 is a schematic diagram of a display panel provided by an embodiment of the present application. In conjunction with the pixel circuit shown in FIG. 1, multiple pixel circuits 40 are arranged in a first direction x to form pixel circuit rows 40H. FIG. 42 illustrates four pixel circuit rows 40H: the first pixel circuit row 40H1, the second pixel circuit row 40H2, the third pixel circuit row 40H3, and the fourth pixel circuit row 40H4. The display panel includes a first scan line Sin, a second scan line S2n, and a third scan line Sp. The scan lines and the scan signals provide by the pixel circuits are labeled the same. The first scan line Sin is connected to multiple gate reset transistors T1 in the pixel circuit row 40H, the second scan line S2n is connected to multiple threshold compensation transistors T3 in the pixel circuit row 40H, and the third scan line Sp is connected to multiple data write transistors T5 in the pixel circuit row 40H. As shown in FIG. 42, the shift register unit VSR outputs a first scan signal sn and two second scan signals sp. The second scan signal sp includes a first sub-scan signal sp1 and a second sub-scan signal sp2. The low-level start time of the second sub-scan signal sp2 is later than the low-level start time of the first sub-scan signal sp1.

At least part of the shift register units VSR output the first scan signal sn to the two second scan lines S2n that drive two adjacent pixel circuit rows 40H and output the first sub-scan signal sp1 and the second sub-scan signal sp2 to the two third scan lines Sp that drive the two adjacent pixel circuit rows 40H.

The shift register unit VSR(0) at the 0 stage outputs the first scan signal sn to the first scan line S1n that drives the first pixel circuit row 40H and the first scan line S1n that drives the second pixel circuit row 40H. The first scan signal sn serves as the scan signal Sin that drives the gate reset transistor T1.

The shift register unit VSR(p) at the p^{th} stage outputs a first scan signal sn (serving as the scan signal S2n for driving the threshold compensation transistor T3) to the second scan line S2n driving the first pixel circuit row 40H and the second scan line S2n driving the second pixel circuit row 40H, outputs a first sub-scan signal sp1 (serving as the scan signal Sp for driving the data write transistor T5) to the third scan line Sp driving the first pixel circuit row 40H, outputs a second sub-scan signal sp2 (serving as the scan signal Sp for driving the data write transistor T5) to the third scan line Sp driving the second pixel circuit row 40H, and outputs a first scan signal sn (serving as the scan signal S1n for driving the gate reset transistor T1) to the first scan line driving the (2p+1)^{th} pixel circuit row 40H and the first scan line sn driving the (2p+2)^{th} pixel circuit row 40H, where p is an integer and p≥1.

Taking the shift register unit provided in the embodiment of FIG. 18 as an example, and referring to FIG. 24, when the shift register unit is operating, the high-level pulse period of the first scan signal sn overlaps the low-level pulse periods of the two second scan signals sp. Therefore, the first scan signal sn and the two second scan signals sp output by the first-stage shift register unit VSR can be configured to drive two pixel circuit rows 40H. The first scan signal sn is configured to drive the threshold compensation transistors T3 in the two pixel circuit rows 40H, and the data write transistors T5 in the two pixel circuit rows 40H each are driven by a second scan signal sp. Furthermore, when driving the pixel circuits using the timing illustrated in FIG. 2, the first scan signal sn output by the shift register unit VSR can also be configured to drive the gate reset transistors T1 in the other two pixel circuit rows 40H.

Since the scan signal Sin and scan signal S2n required by a pixel circuit are asynchronous, the high-level periods of the two cannot overlap. Therefore, in this embodiment of the present application, a preamplifier circuit is provided to provide the scan signal S1n required by the gate reset transistor T1. When p=1, a single stage of pre-stage shift register unit is provided, as illustrated in FIG. 42 using p=1. When p=2, two stages of pre-stage shift register units are required. The pre-stage shift register units output a first scan signal sn to the corresponding scan line, and the output second scan line sp is unused. In practice, the number of pre-stage circuits is determined based on the relationship between the pulse width of the first scan signal sn and the pulse width of the clock signal.

In this embodiment, one first scan signal sn drives two pixel circuit rows 40H and one second scan signal sp drives one pixel circuit row 40H.

In one embodiment, FIG. 43 is a schematic diagram of a circuit layout of a display panel provided by an embodiment of the present application. As shown in FIG. 43, a light-emitting driver circuit Em and a merged driver circuit 50 are provided on one side of the display region AA of the display panel, and a merged driver circuit 50 and a scan driver circuit SpX are provided on the other side of the display region AA of the display panel. Each stage of the shift register units in the light-emitting driver circuit Em is configured to provide the light-emitting control signal Em required by the pixel circuits, and each stage of the shift register units in the scan driver circuit SpX is configured to provide the scan signal SpX required by the pixel circuits. The merged driver circuits 50 on both sides of display region AA have the same structure, and the merged driver circuits 50 are shift registers composed of multiple shift register units according to embodiments of the present application. The merged driver circuit 50 provides the scan signal S1n, the scan signal S2n, and the scan signal Sp required by the pixel circuits. The connections of each stage of the shift register units and the pixel circuit rows in the merged driver circuit 50 can be referred to the schematic diagram of FIG. 42. The scan signal S1n and the scan signal S2n each are a signal for driving two pixel circuit rows, and the scan signal Sp is a signal for driving one pixel circuit row. In this embodiment, two sets of driver circuits are provided on one side of the display panel, which can narrow the bezel of the panel. Furthermore, the number of clock signals required by the entire display panel is reduced, thereby reducing the power consumption of the display panel.

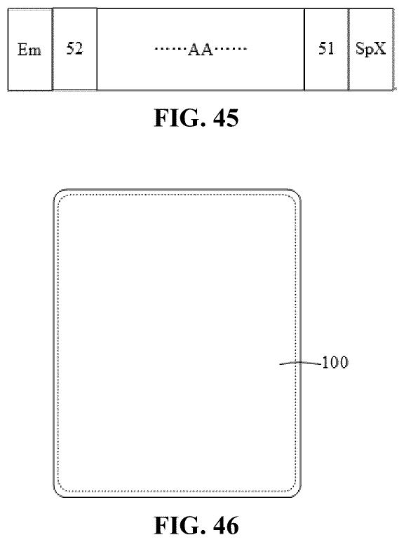

In some embodiments, FIG. 44 is another schematic diagram of a display panel provided by an embodiment of the present application. In conjunction with the pixel circuit shown in FIG. 1, the connection relationship of the first scan line S1n, the second scan line S2n, and the third scan line Sp with the transistors in the pixel circuit row 40H in FIG. 44 is the same as that in FIG. 42, which is not be repeated here. Multiple pixel circuits 40 are arranged in a first direction x to form pixel circuit rows 40H; FIG. 44 illustrates four pixel circuit rows 40H. As shown in FIG. 45, the shift register includes a first shift register and a second shift register. The first shift register includes a plurality of first shift register units 1VSR connected in cascade and the second shift register includes a plurality of second shift register units 2VSR connected in cascade.

The first shift register unit 1VSR and the second shift register unit 2VSR each output a first scan signal sn and two second scan signals sp. The second scan signal sp includes a first sub-scan signal sp1 and a second sub-scan signal sp2; a low-level start time of the second sub-scan signal sp2 is later than a low-level start time of the first sub-scan signal sp1.

The first shift register unit 1VSR provides a scan signal S2n and a scan signal Sp required by the pixel circuits. The first shift register unit 1VSR(m) at the m^{th} stage outputs a first scan signal sn to the second scan line S2n driving the (2m−1)^{th} pixel circuit row 40H and the second scan line S2n driving the 2m^{th} pixel circuit row 40H, outputs a first sub-scan signal sp1 to the third scan line Sp driving the (2m−1)^{th} pixel circuit row 40H, and outputs a second sub-scan signal sp2 to the third scan line Sp driving the (2m)^{th} pixel circuit row 40H, m is an integer, and m≥1; for example, m=1, the first shift register unit 1VSR(1) at the first stage outputs a first scan signal sn to the second scan lines S2n of the first pixel circuit row 40H1 and the second pixel circuit row 40H2, and outputs a first sub-scan signal sp1 to the third scan line Sp of the first pixel circuit row 40H1 and a second sub-scan signal sp2 to the third scan line Sp of the second pixel circuit row 40H2.

The second shift register unit 2VSR provides the scan signal S1n and the scan signal Sp required by the pixel circuits. At least part of the second shift register units 2VSR output the first scan signal sn to the two first scan lines Sin driving two adjacent pixel circuit rows 40H, and output the first sub-scan signal sp1 and the second sub-scan signal sp2 to the two third scan lines Sp driving two other adjacent pixel circuit rows 40H respectively. The second shift register unit 2VSR(0) at the 0th stage outputs a first scan signal s1n to the first scan line S1n driving the first pixel circuit row 40H and the first scan line S1n driving the second pixel circuit row 40H.

The second shift register unit 2VSR(p) at the p^{th} stage outputs a first sub-scan signal sp1 to the third scan line Sp driving the first pixel circuit row 40H, outputs a second sub-scan signal sp2 to the third scan line Sp driving the second pixel circuit row 40H, and outputs a first scan signal sn to the first scan line S1n driving the (2p+1)^{th} pixel circuit row 40H and the first scan line S1n driving the (2p+2)^{th} pixel circuit row 40H, where p is an integer and p≥1.

It can be understood from the description of the embodiment of FIG. 42 that the first shift register unit 1VSR provides the scan signal S2n and the scan signal Sp required by the pixel circuits, and the second shift register unit 2VSR provides the scan signal Sin and the scan signal Sp required by the pixel circuits. However, the high-level pulse period of the first scan signal sn output by the shift register unit provided in the embodiments of the present application overlaps the low-level pulse period of the two second scan signals sp. When the second shift register unit 2VSR is configured to provide the scan signal S1n and the scan signal Sp required by the pixel circuits, the first scan signal sn and the second scan signal sp output by the second shift register unit 2VSR cannot be provided to the same pixel circuit row. In the embodiment of FIG. 44, a pre-stage shift register unit is required for the second shift register unit 2VSR. FIG. 44 takes p=1 as an example, indicating that a pre-stage second shift register unit 2VSR is provided in the second shift register. The first scan signal sn output by the pre-stage second shift register unit 2VSR provides the scan signal S1n required by the first pixel circuit row 40H1 and the second pixel circuit row 40H2.

In another embodiment, FIG. 45 is another schematic diagram of a circuit layout of a display panel provided by an embodiment of the present application. As shown in FIG. 45, a light-emitting driver circuit Em and a first merged driver circuit 51 are provided on one side of the display region AA of the display panel, and a second merged driver circuit 52 and a scan driver circuit SpX are provided on the other side of the display region AA of the display panel. The first merged driver circuit 51 and the second merged driver circuit 52 are both shift registers composed of multiple shift register units provided by embodiments of the present application. For example, the first merged driver circuit 51 is the first shift register in the embodiment of FIG. 44, which provides the scan signal S2n and the scan signal Sp required by the pixel circuits. The second merged driver circuit 52 is the second shift register in the embodiment of FIG. 44, which provides the scan signal Sn and the scan signal Sp required by the pixel circuits.

In the embodiment of FIG. 45, the first merged driver circuit 51 and the second merged driver circuit 52 can be shift register units in the embodiment of FIG. 18, and the first scan signal sn output by each of the first merged driver circuit 51 and the second merged driver circuit 52 includes a high-level pulse. The first merged driver circuit 51 and the second merged driver circuit 52 may be the shift register units in the embodiment of FIG. 19. By setting the signal timing, the first scan signal sn output by the first merged driver circuit 51 includes two high-level pulses, while the first scan signal sn output by the second merged driver circuit 52 includes one high-level pulse.

Based on the same inventive concept, the embodiments of the present application also provide a display apparatus. FIG. 46 is a schematic diagram of a display apparatus provided by an embodiment of the present application. As shown in FIG. 46, the display apparatus includes a display panel 100 provided by any embodiment of the present application. The display panel includes a shift register unit provided by an embodiment of the present application. The structure of the shift register unit has been described in the above embodiments and is not repeated here. The display panel provided by the embodiments of the present application may be, for example, an electronic device with a display function, such as a mobile phone, tablet, computer, television, or smart wearable product.

What is claimed is:

1. A display panel, comprising a shift register which comprises a plurality of cascaded shift register units, each of the plurality of shift register units comprising a control module, a first output module, and a second output module,
wherein the first output module is connected to at least one output terminal of the control module, and the second output module is connected to at least one output terminal of the control module and/or to an output terminal of the first output module;
the control module is configured to output a control signal based at least on a first input signal;
the first output module is configured to output a first scan signal based at least on the control signal output by the control module, a high level of the first scan signal being an enable level; and
the second output module is configured to output at least one second scan signal based at least on the control signal output by the control module and/or a signal output by the first output module, a low level in the second scan signal being an enable level.

2. The display panel according to claim 1, wherein the control module is configured to output the control signal based on the first input signal, a first clock signal, a first voltage signal, and a second voltage signal;
the first output module is configured to output the first scan signal based on the control signal output by the control module, the first voltage signal, and the second voltage signal; and
the second output module is configured to output the at least one second scan signal based on the first voltage signal, the second voltage signal, at least one clock signal, and based on the control signal output by the control module and the signal output by the first output module, or based on an output signal of the first output module and a second input signal, or based on the control signal output by the control module, or based on the control signal output by the control module and the second input signal.

3. The display panel according to claim 2, wherein the first output module comprises a first inverter, an input terminal of the first inverter being connected to the output terminal of the control module, and the first inverter outputting the first scan signal based on the control signal output by the control module;
the control module comprises a first submodule and a second inverter, the first submodule receiving the first input signal, the first submodule being connected to an input terminal of the second inverter, an output terminal of the second inverter being connected to an input terminal of the first inverter, and the first submodule being configured to write the first input signal to the input terminal of the second inverter under a control of a first clock signal; and
at least one control terminal of the second output module is connected to an output terminal of the first inverter, and at least one input terminal of the second output module is connected to the input terminal of the first inverter or receives a second input signal.

4. The display panel according to claim 3, wherein the at least one input terminal of the second output module receives the second input signal; a pulse level of the first input signal is a high level, and a pulse level of the second input signal is a low level; an input terminal of the first submodule in the shift register unit at an i^{th} stage is connected to the output terminal of the first inverter in the shift register unit at an (i−1)^{th} stage, and the input terminal of the second output module in the shift register unit at the i^{th} stage receives the second scan signal output by the shift register unit at the (i−1)^{th} stage, where i is an integer and i≥2; or
the at least one input terminal of the second output module is connected to the input terminal of the first inverter; the pulse level of the first input signal is a high level, and the input terminal of the first submodule in the shift register unit at the i^{th} stage is connected to the output terminal of the first inverter in the shift register unit at the (i−1)^{th} stage, where i is an integer and i≥2.

5. The display panel according to claim 2, wherein the control module comprises a first submodule, a first inverter, and a second inverter; the first submodule receives the first input signal, the first submodule is connected to an input terminal of the second inverter, and the output terminal of the second inverter is connected to the input terminal of the first inverter;
the first submodule is configured to write the first input signal to the input terminal of the second inverter under a control of a first clock signal;
the first output module comprises a third inverter, an input terminal of the third inverter is connected to the output terminal of the control module, and the third inverter outputs the first scan signal based at least on the control signal output by the control module; and
at least one control terminal of the second output module is connected to the output terminal of the second inverter or to the output terminal of the first output module, and at least one input terminal of the second output module is connected to the output terminal of the first inverter or receives a second input signal.

6. The display panel according to claim 5, wherein the at least one input terminal of the second output module is connected to the output terminal of the first inverter, the pulse level of the first input signal is the low level; the input terminal of the first submodule in the shift register unit at the i^{th} receives the second scan signal output by the shift register unit at the (i−1)^{th} stage, where i is an integer and i≥2; and
the at least one input terminal of the second output module receives a second input signal, the pulse level of the first input signal is the high level, and the pulse level of the second input signal is the low level; the input terminal of the first submodule in the shift register unit at the i^{th} stage is connected to the output terminal of the first inverter in the shift register unit at the (i−1)^{th} stage, and the input terminal of the second output module in the shift register unit at the i^{th} stage receives the second scan signal output by the shift register unit at the (i−1)^{th} stage, where i is an integer and i≥2.

7. The display panel according to claim 1, wherein the first output module is configured to output the first scan signal based at least on the control signal output by the control module and a first level signal of a refresh control signal, and to output a low-level constant voltage signal based at least on the control signal output by the control module and a second level signal of the refresh control signal; and
one of the first level signal and the second level signal is a high-level signal, and the other one is a low-level signal.

8. The display panel according to claim 1, wherein the control module is configured to output the control signal based on the first input signal, a first clock signal, a first voltage signal, and a second voltage signal;
the control module comprises a first input module and a first inverter, an input terminal of the first input module receives the first input signal, an output terminal of the first input module is connected to an input terminal of the first inverter; and
the first output module and the second output module each are connected to the first inverter.

9. The display panel according to claim 1, wherein the second output module is configured to output the at least one second scan signal based on a first voltage signal, a second voltage signal, at least one clock signal, and the control signal output by the control module and the signal output by the first output module, or based on a second input signal and an output signal of the first output module, or based on the control signal output by the control module, or based on the control signal output by the control module and the second input signal.

10. The display panel according to claim 9, wherein the second output module comprises at least one submodule;
a control terminal of the at least one submodule is connected to the control module or the first output module;
an input terminal of the at least one submodule is connected to the control module or the first output module, or receives the second input signal.

11. The display panel according to claim 10, wherein the submodule comprises a ninth transistor, a tenth transistor, and an eleventh transistor; and
a control terminal of the ninth transistor receives the first voltage signal; a first terminal of the ninth transistor is connected to the control module or the first output module or receives the second input signal; a second terminal of the ninth transistor is connected to a control terminal of the tenth transistor; a first terminal of the tenth transistor receives a second clock signal; a control terminal of the eleventh transistor is connected to the control module or the first output module; a first terminal of the eleventh transistor receives the second voltage signal; an output terminal of the tenth transistor and an output terminal of the eleventh transistor are connected to an output terminal of the submodule.

12. The display panel according to claim 10, wherein one input terminal of the submodule receives the second input signal via a second input module; and
the second input module is configured to write the second input signal to the submodule based on a control of the first clock signal.

13. The display panel according to claim 7, wherein the shift register unit comprises a first mode and a second mode;
in the first mode, the first output module outputs the first scan signal, and the second output module outputs the at least one second scan signal;
in the second mode, the first output module outputs a low-level constant voltage signal, and the second output module outputs the at least one second scan signal.

14. The display panel according to claim 13, wherein the refresh control signal comprises a first-level signal and a second-level signal;
the shift register comprises N stages of the shift register units, where N is an integer;
the display panel comprises a first refresh frame, and in the first refresh frame:
the shift register unit at the j^{th} stage to the shift register unit at the q^{th} stage receive the first level signal of the refresh control signal, and the shift register unit at the j^{th} stage to the shift register unit at the q^{th} stage are in the first mode, where j and q are integers, and 1≤j<q<N;
the shift register unit at the (q+1)^{th} stage to the shift register unit at the w^{th} stage receive the second level signal of the refresh control signal, and the shift register unit at the (q+1)^{th} stage to the shift register unit at the w^{th} stage are in the second mode, where w is an integer, and q+1<W≤N.

15. A display apparatus, comprising a display panel which comprises a shift register, the shift register comprising a plurality of cascaded shift register units, each of the plurality of shift register units comprising a control module, a first output module, and a second output module,
wherein the first output module is connected to at least one output terminal of the control module, and the second output module is connected to at least one output terminal of the control module and/or to an output terminal of the first output module;
the control module is configured to output a control signal based at least on a first input signal;
the first output module is configured to output a first scan signal based at least on the control signal output by the control module, a high level of the first scan signal being an enable level; and
the second output module is configured to output at least one second scan signal based at least on the control signal output by the control module and/or a signal output by the first output module, a low level in the second scan signal being an enable level.

16. A method for driving a display panel, wherein the display panel comprises a shift register, the shift register comprises a plurality of cascaded shift register units, each of the plurality of shift register units comprises a control module, a first output module, and a second output module, the first output module is connected to at least one output terminal of the control module, and the second output module is connected to at least one output terminal of the control module, and/or to the output terminal of the first output module;
the driving method comprises:
providing a first input signal to the control module in each of the shift register units, and controlling the control module to output a control signal based at least on the first input signal;
controlling the first output module to output a first scan signal based at least on the control signal output by the control module, wherein a high level in the first scan signal serves as an enable level; and
controlling the second output module to output at least one second scan signal based at least on the control signal output by the control module and/or a signal output by the first output module, wherein a low level in the second scan signal serves as an enable level.

17. The driving method according to claim 16, wherein the providing a first input signal to the control module, and controlling the control module to output a control signal based at least on the first input signal comprises: providing the first input signal and a first clock signal to the control module, and controlling the control module to output the control signal;
the controlling the first output module to output a first scan signal based at least on the control signal output by the control module comprises: controlling the first output module to begin outputting a high-level signal of the first scan signal during a period when a pulse of the first input signal overlaps a first low level of the first clock signal, and controlling the first output module to stop outputting the high-level signal of the first scan signal during a period when a non-pulse of the first input signal overlaps a second low level of the first clock signal, wherein the second low level is the sth pulse signal after the first low level, where s is a positive integer;
the controlling the second output module to output at least one second scan signal based at least on the control signal output by the control module and/or the signal output by the first output module comprises: controlling the second output module to output the at least one low-level signal of the second scan signal during a period when the first clock signal provides the first low level and the second low level.

18. The driving method according to claim 17, wherein the controlling the second output module to output the at least one low-level signal of the second scan signal during a period when the first clock signal provides the first low level and the second low level comprises: controlling the second output module to output the at least one low-level signal of the second scan signal based on at least one clock signal, wherein a low-level period of the clock signal received by the second output module corresponds to a low-level period of the second scan signal.

19. The driving method according to claim 18, wherein the controlling the second output module to output the at least one low-level signal of the second scan signal based at least on the control signal output by the control module and/or the signal output by the first output module comprises: controlling the second output module to output at least one low-level signal of the second scan signal based at least on the second input signal, the control signal output by the control module, or the signal output by the first output module, wherein the second input signal is written to the second output module during a period when the first clock signal provides the low level.

20. The driving method according to claim 16, wherein the controlling the first output module to output a first scan signal based at least on the control signal output by the control module comprises: controlling the first output module to output the first scan signal based at least on the first-level signal of the refresh control signal and the control signal output by the control module;
the driving method further comprises: controlling the first output module to output the low-level constant voltage signal based at least on the second level signal of the refresh control signal and the control signal output by the control module; wherein one of the first level signal and the second level signal is a high-level signal, and the other one is a low-level signal.
